(19) United States
(12) Patent Application Publication
(10) Pub. No.: US 2019/0266890 A1
(43) Pub. Date: Aug. 29, 2019

(54) METHODS AND APPARATUS FOR PRESENTING LANE AND VEHICLE TYPE-SPECIFIC TRAFFIC INFORMATION ON A MAP

(71) Applicant: Ford Motor Company, Dearborn, MI (US)

(72) Inventors: Oliver LEI, Windsor (CA); Al R. MURRAY, Lake Orion, MI (US)

(21) Appl. No.: 16/342,607

(22) PCT Filed: Oct. 20, 2016
(86) PCT No.: PCT/US2016/057839

§ 371 Date: Apr. 17, 2019

(51) Int. Cl. G08G 1/01; G08G 1/015; G08G 1/0969; G08G 1/0967

(52) U.S. Cl. CPC G08G 1/0125; G08G 1/015; G01C 21/3492; G08G 1/096775; G08G 1/012; G08G 1/0969

(57) ABSTRACT

Methods and apparatus for presenting lane and vehicle type-specific traffic information on a map of a user interface of an electronic device are disclosed herein. An electronic device comprises a user interface to present lane and vehicle type-specific traffic information on a map. The map includes a roadway having a plurality of adjacent lanes to carry vehicle traffic in a first direction. The lane and vehicle type-specific traffic information is determined based on lane type identification data and vehicle type identification data provided by vehicles traveling on the lanes of the roadway in the first direction.

### FIELD OF THE DISCLOSURE

This disclosure relates generally to methods and apparatus for presenting traffic information and, more specifically, to methods and apparatus for presenting lane and vehicle type-specific traffic information on a map of a user interface of an electronic device.

### BACKGROUND

Conventional navigation systems generate and present traffic information derived from the position, direction and speed of vehicles traveling on roadways. Such conventional navigation systems assume that the vehicles traveling on various same-direction adjacent lanes of a roadway are traveling at the same speed. In other words, the traffic information presented via such conventional navigation systems is based on an average speed of all vehicles traveling on all adjacent lanes of one or more segments of a roadway. Accordingly, the traffic information presented via such conventional navigation systems does not differentiate between the adjacent lanes of traffic on the roadway and/or between different types of adjacent lanes of traffic on the roadway (e.g., a regular lane versus a carpool lane).

The traffic information presented via such conventional navigation systems also does not differentiate between different types of vehicles (e.g., cars versus trucks) from which the traffic information is derived when different types of vehicles use different lanes (e.g., a car only lane versus a truck only lane on a bridge or in a tunnel). Accordingly, the approach of generating and presenting traffic information followed by conventional navigation systems fails to generate and/or present traffic information that is lane type-specific and/or vehicle type-specific.

### SUMMARY

Methods and apparatus for presenting lane and vehicle type-specific traffic information on a map of a user interface of an electronic device are disclosed herein. In some examples, an electronic device is disclosed. In some disclosed examples, the electronic device comprises a user interface to present lane and vehicle type-specific traffic information on a map. In some disclosed examples, the map includes a roadway having a plurality of adjacent lanes to carry vehicle traffic in a first direction. In some disclosed examples, the lane and vehicle type-specific traffic information is determined based on lane type identification data and vehicle type identification data provided by vehicles traveling on the lanes of the roadway in the first direction.

In some examples, a method is disclosed. In some disclosed examples, the method comprises presenting lane and vehicle type-specific traffic information on a map of a user interface of an electronic device. In some disclosed examples, the map includes a roadway having a plurality of adjacent lanes to carry vehicle traffic in a first direction. In some disclosed examples, the lane and vehicle type-specific traffic information is determined based on lane type identification data and vehicle type identification data provided by vehicles traveling on the lanes of the roadway in the first direction.

In some examples, a tangible machine readable storage medium comprising instructions is disclosed. In some disclosed examples, the instructions, when executed, cause a processor to present lane and vehicle type-specific traffic information on a map of a user interface of an electronic device. In some disclosed examples, the map includes a roadway having a plurality of adjacent lanes to carry vehicle traffic in a first direction. In some disclosed examples, the lane and vehicle type-specific traffic information is determined based on lane type identification data and vehicle type identification data provided by vehicles traveling on the lanes of the roadway in the first direction.

### BRIEF DESCRIPTION OF THE DRAWINGS

FIG. 1 illustrates a first example environment of use in which an example onboard navigation system of an example vehicle detects example rumble strips located on example lanes of an example roadway.

FIG. 2 illustrates a second example environment of use in which an example onboard navigation system of an example vehicle detects example data tags located on example lanes of an example roadway.

FIG. 3 is a block diagram of the example onboard navigation system of FIGS. 1 and 2 constructed in accordance with the teachings of this disclosure.

FIG. 4 is a block diagram of the example remote server of FIGS. 1 and 2 constructed in accordance with the teachings of this disclosure.

FIG. 5 is a block diagram of the example mobile device of FIGS. 1 and 2 constructed in accordance with the teachings of this disclosure.

FIG. 6 illustrates the example user interface of the example onboard navigation system of FIGS. 1-3 presenting an example map including example lane and vehicle type-specific traffic information.

FIG. 7 illustrates the example user interface of the example onboard navigation system of FIGS. 1-3 presenting an example route based on an example vehicle type, an example lane type, and example lane and vehicle type-specific traffic information.

FIG. 8 is a flowchart representative of an example method that may be executed at the example onboard navigation system of FIGS. 1-3 to collect and transmit example vehicle travel data of an example vehicle.

FIG. 9 is a flowchart representative of an example method that may be executed at the example remote server of FIGS. 1, 2 and 4 to generate and transmit example lane and vehicle type-specific traffic information.

FIG. 10 is a flowchart representative of an example method that may be executed at the example onboard navigation system of FIGS. 1-3 and/or at the example mobile device of FIGS. 1, 2 and 5 to present example lane and vehicle type-specific traffic information.

FIG. 11 is an example processor platform capable of executing instructions to implement the methods of FIGS. 8 and 10 and the example onboard navigation system of FIGS. 1-3.

FIG. 12 is an example processor platform capable of executing instructions to implement the method of FIG. 9 and the example remote server of FIGS. 1, 2 and 4.

FIG. 13 is an example processor platform capable of executing instructions to implement the method of FIG. 10 and the example mobile device of FIGS. 1, 2 and 5.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

### DETAILED DESCRIPTION

Conventional navigation systems generate and present traffic information derived from data including the position, direction and speed of vehicles traveling on roadways. The traffic information presented via such conventional navigation systems does not differentiate between the adjacent lanes of traffic on the roadway and/or between different types of adjacent lanes of traffic on the roadway (e.g., a regular lane versus a carpool lane). The traffic information presented via such conventional navigation systems also does not differentiate between different types of vehicles (e.g., cars versus trucks) from which the traffic information is derived when different types of vehicles use different lanes (e.g., a car only lane versus a truck only lane on a bridge or in a tunnel). Accordingly, the approach of generating and presenting traffic information followed by conventional navigation systems fails to generate and/or present traffic information that is lane type-specific and/or vehicle type-specific.

Unlike conventional navigation systems that generate and present traffic information of limited detail and/or granularity, the methods and apparatus disclosed herein generate and present lane and vehicle type-specific traffic information on a map of a user interface of an electronic device (e.g., an onboard navigation system, a mobile device, etc.). As used herein, the term “lane and vehicle type-specific traffic information” refers generally to traffic information having a degree of granularity that is specific to one or more type(s) of vehicle(s) traveling on a roadway and one or more type(s) of lane(s) on which such vehicle(s) is/are traveling. Example vehicle types include cars, trucks, motorcycles, buses, recreational vehicles, etc. Example lane types include regular, carpool, express, paid, reserved, restricted, isolated, etc.

The lane and vehicle type-specific traffic information generated and presented via the disclosed methods and apparatus advantageously provides end users with traffic information of an increased level of detail and/or granularity relative to the traffic information generated and presented via conventional navigation systems. The increased granularity provided by the lane and vehicle type-specific traffic information of the disclosed methods and apparatus advantageously enables end users to more wisely plan and/or select their travel routes. For example, an end user driving a car and having a specific interest in traffic information for a carpool lane may utilize the lane and vehicle type-specific traffic information generated and presented via the disclosed methods and apparatus to differentiate and/or focus on traffic information pertaining to cars traveling in a carpool lane of a roadway, as opposed to cars and/or other types of vehicles traveling in other adjacent lanes of the roadway.

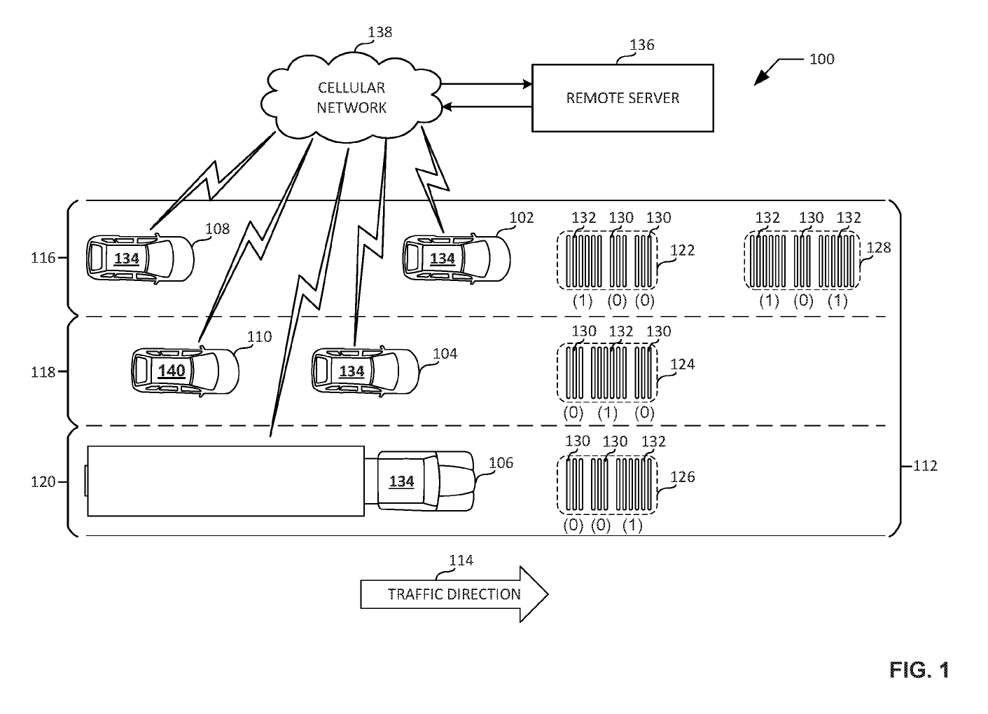

FIG. 1 illustrates a first example environment of use 100 in which an example onboard navigation system of an example vehicle detects example rumble strips located on example lanes of an example roadway. In the illustrated example of FIG. 1, each of a first example vehicle 102, a second example vehicle 104, a third example vehicle 106, a fourth example vehicle 108 and a fifth example vehicle 110 travels along an example roadway 112 in an example first direction 114. The first, second, fourth and fifth vehicles 102, 104, 108, 110 are cars, while the third vehicle 106 is a truck. Although the example of FIG. 1 illustrates five vehicles (e.g., the first, second, third fourth and fifth vehicles 102, 104, 106, 108, 110) and two different vehicle types (e.g., cars and trucks), any number and/or any type(s) of vehicles may travel along the roadway 112.

The roadway of FIG. 1 includes a first example lane 116, a second example lane 118 and a third example lane 120. The first, second and third lanes 116, 118, 120 are adjacent one another and carry vehicle traffic in the first direction 114. The first lane 116 is the leftmost lane of the roadway 112 relative to the first direction 114 of traffic. In some examples, the first lane 116 may be a carpool lane. The second lane 118 is the center lane of the roadway 112 relative to the first direction 114 of traffic. In some examples, the second lane 118 may be a regular lane intended to carry any type of vehicle traffic. The third lane 120 is the rightmost lane of the roadway 112 relative to the first direction 114 of traffic. In some examples, the third lane 120 may be reserved for and/or may be most commonly used by trucks. In some example one or more of the adjacent first, second and/or third lane(s) 116, 118, 120 may be separated from one another via one or more physical barrier(s) and/or lane divider(s) (not shown) located on the roadway 112. Although the example of FIG. 1 illustrates three lanes (e.g., the first, second and third lanes 116, 118, 120) of the roadway 112, the roadway 112 may contain any number and/or any type(s) of lanes.

In the illustrated example of FIG. 1, the first lane 116 includes a first example set of rumble strips 122, the second lane 118 includes a second example set of rumble strips 124, and the third lane 120 includes a third example set of rumble strips 126. The first lane 116 further includes a fourth example set of rumble strips 128. The first, second, third and fourth sets of rumble strips 122, 124, 126, 128 may be placed on, formed on and/or formed in the roadway 112. Each of the first, second, third and fourth sets of rumble strips 122, 124, 126, 128 includes a unique combination of example shorter rumble strip segments 130 and example longer rumble strip segments 132. For example, the first set of rumble strips 122 includes a longer rumble strip segment 132 followed by a first shorter rumble strip segment 130 followed by a second shorter rumble strip segment 130, while the second set of rumble strips 124 includes a first shorter rumble strip segment 130 followed by longer rumble strip segment 132 followed by a second shorter rumble strip segment 130. Although the example of FIG. 1 illustrates four sets of rumble strips (e.g., the first, second, third and fourth sets of rumble strips 122, 124, 126, 128) located on the first, second and third lanes 116, 118, 120 of the roadway 112, with each set of rumble strips including a combined total of three shorter rumble strip segments 130 and/or longer rumble strip segments 132, each of the first, second and third lanes 116, 118, 120 of the roadway 112 may contain any number of sets of rumble strips and/or any number of shorter and/or longer rumble strip segments.

In the illustrated example of FIG. 1, each shorter rumble strip segment 130 is indicative of and/or associated with a value of zero (0), and each longer rumble strip segment 132 is indicative of and/or associated with a value of one (1). Accordingly, each of the first, second, third and fourth sets of rumble strips 122, 124, 126, 128 is indicative of and/or associated with a code that is unique to a corresponding one of the first, second or third lanes 116, 118, 120 on which the first, second, third or fourth set of rumble strips 122, 124, 126, 128 is located. For example, the first set of rumble strips 122 is indicative of the code 1-0-0, which may in turn be indicative of the first lane 116 of the roadway 112 being the leftmost lane of the roadway 112. The second set of rumble strips 124 is indicative of the code 0-1-0, which may in turn be indicative of the second lane 118 of the roadway 112 being the center lane of the roadway 112. The third set of rumble strips 126 is indicative of the code 0-0-1, which may in turn be indicative of the third lane 120 of the roadway 112 being the rightmost lane of the roadway 112. The fourth set of rumble strips 128 is indicative of the code 1-0-1, which may in turn be indicative of the first lane 116 of the roadway 112 being a carpool lane. In other examples, the data and/or information indicated by the first and fourth sets of rumble strips 122, 128 may be combined to be indicated by a single set of rumble strips (e.g., on the first set of rumble strips 122).

In the illustrated example of FIG. 1, each of the first, second and third vehicles 102, 104, 106 includes an example onboard navigation system 134. The onboard navigation system 134 is integral to the vehicle, and may form part of and/or otherwise be in communication with a telematics control unit (TCU) (not shown) of the vehicle. As the vehicle travels over the rumble strips described above, the onboard navigation system 134 detects sounds produced as a result of the wheels of the vehicle contacting the rumble strips. The sequence of sounds detected by the onboard navigation system 134 is indicative of a corresponding code associated with the rumble strips and, accordingly is indicative of a specific lane and/or lane type in which the vehicle including the onboard navigation system 134 is traveling.

For example, as the first vehicle 102 of FIG. 1 travels over the first set of rumble strips 122, the onboard navigation system 134 of the first vehicle 102 detects sounds corresponding to the sequence of rumble strip segments (e.g., a longer rumble strip segment 132 followed by a first shorter rumble strip segment 130 followed by a second shorter rumble strip segment 130) that comprise the first set of rumble strips 122. The onboard navigation system 134 of the first vehicle 102 translates and/or converts the detected sounds into the corresponding code (e.g., 1-0-0) associated with the first set of rumble strips 122. In some examples, the onboard navigation system 134 of the first vehicle 102 may additionally associate the corresponding code (e.g., 1-0-0) with the first lane 116 of the roadway 112 being the leftmost lane of the roadway 112.

The first vehicle 102 of FIG. 1 may additionally travel over the fourth set of rumble strips 128. As the first vehicle 102 travels over the fourth set of rumble strips 128, the onboard navigation system 134 of the first vehicle 102 detects sounds corresponding to the sequence of rumble strip segments (e.g., first longer rumble strip segment 132 followed by a shorter rumble strip segment 130 followed by a second longer rumble strip segment 132) that comprise the fourth set of rumble strips 128. The onboard navigation system 134 of the first vehicle 102 translates and/or converts the detected sounds into the corresponding code (e.g., 1-0-1) associated with the fourth set of rumble strips 128. In some examples, the onboard navigation system 134 of the first vehicle 102 may additionally associate the corresponding code (e.g., 1-0-1) with the first lane 116 of the roadway 112 being a carpool lane of the roadway 112.

As another example, as the second vehicle 104 of FIG. 1 travels over the second set of rumble strips 124, the onboard navigation system 134 of the second vehicle 104 detects sounds corresponding to the sequence of rumble strip segments (e.g., a first shorter rumble strip segment 130 followed by a longer rumble strip segment 132 followed by a second shorter rumble strip segment 130) that comprise the second set of rumble strips 124. The onboard navigation system 134 of the second vehicle 104 translates and/or converts the detected sounds into the corresponding code (e.g., 0-1-0) associated with the second set of rumble strips 124. In some examples, the onboard navigation system 134 of the second vehicle 104 may additionally associate the corresponding code (e.g., 0-1-0) with the second lane 118 of the roadway 112 being the center lane of the roadway 112.

As another example, as the third vehicle 106 of FIG. 1 travels over the third set of rumble strips 126, the onboard navigation system 134 of the third vehicle 106 detects sounds corresponding to the sequence of rumble strip segments (e.g., a first shorter rumble strip segment 130 followed by a second shorter rumble strip segment 130 followed by a longer rumble strip segment 132) that comprise the third set of rumble strips 126. The onboard navigation system 134 of the third vehicle 106 translates and/or converts the detected sounds into the corresponding code (e.g., 0-0-1) associated with the third set of rumble strips 126. In some examples, the onboard navigation system 134 of the third vehicle 106 may additionally associate the corresponding code (e.g., 0-0-1) with the third lane 118 of the roadway 112 being the rightmost lane of the roadway 112.

Each onboard navigation system 134 of the first, second and third vehicles 102, 104, 106 of FIG. 1 transmits vehicle travel data to an example remote server 136 (e.g., a cloud server) via an example cellular network 138. In the illustrated example of FIG. 1, the remote server 136 is a backend server that is in wired communication with the cellular network 138. The cellular network 138 may be a multi-cellular network that provides and/or enables connections and/or communications with, among and/or between different cellular service providers and/or carriers (e.g., Verizon®, AT&T®, Sprint®, T-Mobile®, etc.).

The vehicle travel data transmitted to the remote server 136 via the cellular network 138 may include vehicle position data, vehicle direction data, vehicle speed data, vehicle type identification data (e.g., whether the vehicle is a car, a truck, etc.) and lane type identification data (e.g., whether the vehicle is traveling in a leftmost lane, a center lane, a rightmost lane, a carpool lane, etc.). For example, the onboard navigation system 134 of the first vehicle 102 of FIG. 1 may transmit vehicle travel data to the remote server 136 via the cellular network 138 including vehicle position data, vehicle direction data and vehicle speed data determined by the first vehicle 102. The vehicle travel data transmitted by the onboard navigation system 134 of the first vehicle 102 may further include vehicle type identification data that indicates and/or identifies the first vehicle 102 to be a car. The vehicle travel data transmitted by the onboard navigation system 134 of the first vehicle 102 may further include lane type identification data that indicates and/or identifies the first vehicle 102 to be traveling in the leftmost lane of the roadway 112 and/or in a carpool lane of the roadway 112 (e.g., in the first lane 116 of the roadway).

As another example, the onboard navigation system 134 of the second vehicle 104 of FIG. 1 may transmit vehicle travel data to the remote server 136 via the cellular network 138 including vehicle position data, vehicle direction data and vehicle speed data determined by the second vehicle 104. The vehicle travel data transmitted by the onboard navigation system 134 of the second vehicle 104 may further include vehicle type identification data that indicates and/or identifies the second vehicle 104 to be a car. The vehicle travel data transmitted by the onboard navigation system 134 of the second vehicle 104 may further include lane type identification data that indicates and/or identifies the second vehicle 104 to be traveling in the center lane of the roadway 112 and/or in a regular lane of the roadway 112 (e.g., in the second lane 118 of the roadway).

As another example, the onboard navigation system 134 of the third vehicle 106 of FIG. 1 may transmit vehicle travel data to the remote server 136 via the cellular network 138 including vehicle position data, vehicle direction data and vehicle speed data determined by the third vehicle 106. The vehicle travel data transmitted by the onboard navigation system 134 of the third vehicle 106 may further include vehicle type identification data that indicates and/or identifies the third vehicle 106 to be a truck. The vehicle travel data transmitted by the onboard navigation system 134 of the third vehicle 106 may further include lane type identification data that indicates and/or identifies the third vehicle 106 to be traveling in the rightmost lane of the roadway 112 and/or in a lane of the roadway 112 reserved for and/or most commonly used by trucks (e.g., in the third lane 120 of the roadway).

As described in greater detail herein, the remote server 136 of FIG. 1 sorts, classifies, organizes and/or otherwise groups the vehicle travel data received via the cellular network 138 from the various vehicles (e.g., the first, second and third vehicles 102, 104, 106) traveling along the roadway 112 to generate lane and vehicle type-specific traffic information. The lane and vehicle type-specific traffic information includes coding (e.g., one or more graphic(s)) that provides an indication of particular portions represented by the lane and vehicle type-specific traffic information. For example, a first portion of the lane and vehicle type-specific traffic information may be graphically represented by a first line thickness, a first symbol and a first color. The first line thickness may be indicative of traffic for cars, the first symbol may be indicative of a carpool lane, and the first color may be indicative of low density (e.g., clear and/or fast moving) traffic. As another example, a second portion of the lane and vehicle type-specific traffic information may be graphically represented by a second line thickness, a second symbol and a second color. The second line thickness may be indicative of traffic for trucks, the second symbol may be indicative of a regular lane, and the second color may be indicative of high density (e.g., heavy and/or slow moving) traffic. The lane and vehicle type-specific traffic information may include any number, type(s) and/or combination(s) of coding and/or graphic(s) indicative of any number of portion(s) represented by the lane and vehicle type-specific traffic information.

In the illustrated example of FIG. 1, the fourth vehicle 108 includes an onboard navigation device 134. The onboard navigation device 134 of the fourth vehicle 108 may transmit one or more request(s) to the remote server 136 via the cellular network 138 requesting that the remote server 136 transmit traffic information to the onboard navigation system 134 of the fourth vehicle 108. In some examples, the request may include the current position and/or location of the onboard navigation system 134 and/or of the fourth vehicle 108. In response to the request, the remote server 136 transmits the lane and vehicle type-specific traffic information via the cellular network 138 to the onboard navigation system 134 of the fourth vehicle 108. In some examples, the transmitted lane and vehicle type-specific traffic information may be tailored to the current position and/or location of the onboard navigation system 134 and/or of the fourth vehicle 108.

Once the lane and vehicle type-specific traffic information has been received, the onboard navigation system 134 of the fourth vehicle 108 may present the lane and vehicle type-specific traffic information on a user interface (not shown) of the onboard navigation system 134 of the fourth vehicle 108. In some examples, the user interface may enable an end user to filter the presented lane and vehicle type-specific traffic information to include only the portion(s) of the lane and vehicle type-specific traffic information that are of interest to the end user. For example, the end user may instruct the user interface to filter the presented lane and vehicle type-specific traffic information to include only the portion(s) of the lane and vehicle type-specific traffic information that are specific to cars and/or specific to carpool lanes.

In the illustrated example of FIG. 1, the fifth vehicle 110 includes an example mobile device 140. The mobile device 140 may or may not be integral with the fifth vehicle 110. For example, the mobile device 140 may be a smartphone, a tablet, a laptop computer, etc. that is not integral with the fifth vehicle 110. The mobile device 140 may alternatively be an electronic device that is integral with the fifth vehicle 110, but which may not include all of the components that enable the onboard navigation device 134 described above to collect and transmit vehicle travel data that includes vehicle position data, vehicle direction data, vehicle speed data, vehicle identification data and lane type identification data. Despite the absence of such components relative to the onboard navigation system 134, the mobile device 140 may nevertheless request, receive and present lane and vehicle type-specific traffic information in the same manner as described above in connection with the onboard navigation device 134 of the fourth vehicle 108.

Accordingly, the mobile device 140 may transmit one or more request(s) to the remote server 136 via the cellular network 138 requesting that the remote server 136 transmit traffic information to the mobile device 140. In some examples, the request may include the current position and/or location of the mobile device 140. In response to the request, the remote server 136 transmits the lane and vehicle type-specific traffic information via the cellular network 138 to the mobile device 140. In some examples, the transmitted lane and vehicle type-specific traffic information may be tailored to the current position and/or location of the mobile device 140.

Once the lane and vehicle type-specific traffic information has been received, the mobile device 140 may present the lane and vehicle type-specific traffic information on a user interface (not shown) of the mobile device 140. In some examples, the user interface may enable an end user to filter the presented lane and vehicle type-specific traffic information to include only the portion(s) of the lane and vehicle type-specific traffic information that are of interest to the end user. For example, the end user may instruct the user interface to filter the presented lane and vehicle type-specific traffic information to include only the portion(s) of the lane and vehicle type-specific traffic information that are specific to cars and/or specific to regular (e.g., non-carpool) lanes.

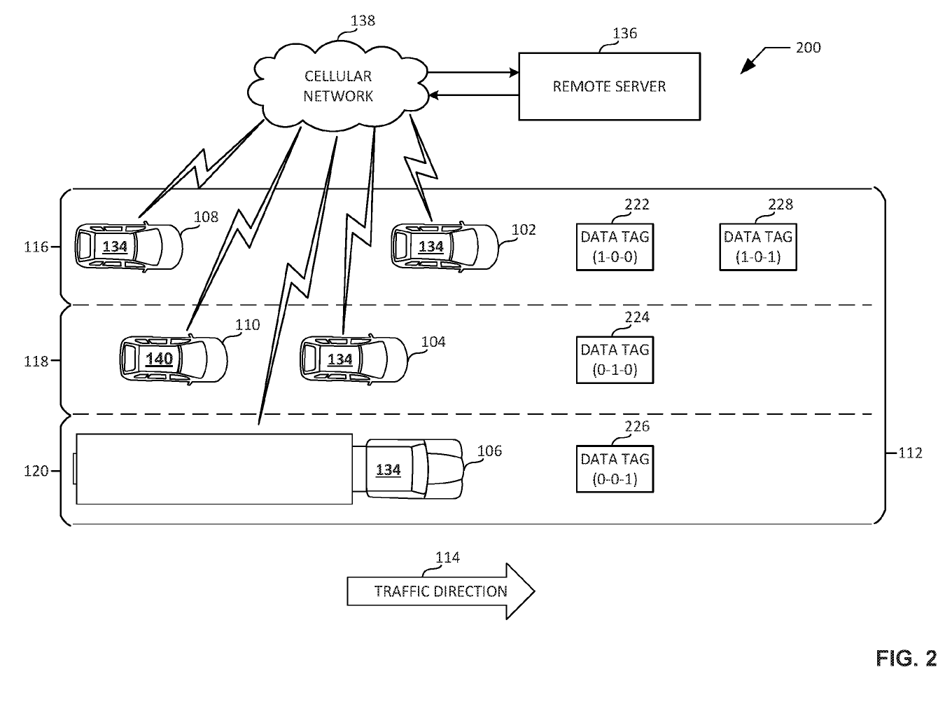

FIG. 2 illustrates a second example environment of use 200 in which an example onboard navigation system of an example vehicle detects example data tags located on example lanes of an example roadway. The environment of use 200 of FIG. 2 includes the vehicles (e.g., the first, second, third, fourth and fifth vehicles 102, 104, 106, 108, 110), the roadway (e.g., the roadway 112), the lanes (e.g., the first, second and third lanes 116, 118, 120), the onboard navigation systems (e.g., the onboard navigation systems 134), the remote server (e.g., the remote server 136), the cellular network (e.g., the cellular network 138) and the mobile device (e.g., the mobile device 140) described above in connection with the environment of use 100 of FIG. 1. The environment of use 200 of FIG. 2 differs from the environment of use 100 of FIG. 1 only with respect to the manner by which the onboard navigation systems 134 detect and/or determine lane type identification data. In this regard, the environment of use 200 of FIG. 2 differs from the environment of use 100 of FIG. 1 in that the environment of use 200 of FIG. 2 includes example data tags in place of the example sets of rumble strips included in the environment of use 100 of FIG. 1. The example data tags of FIG. 2 may be implemented as radio frequency identification (RFID) tags and/or Bluetooth Low Energy (BLE) tags. In the illustrated example of FIG. 2, each onboard navigation system 134 reads and/or detects data (e.g., one or more code(s)) contained on and/or provided by a corresponding data tag as a vehicle including the onboard navigation system 134 travels over the corresponding data tag.

In the illustrated example of FIG. 2, the first lane 116 includes a first example data tag 222, the second lane 118 includes a second example data tag 224, and the third lane 120 includes a third example data tag 226. The first lane 116 further includes a fourth example data tag 228. The first, second, third and fourth data tags 222, 224, 226, 228 may be placed on, affixed to and/or embedded in the roadway 112. Each of the first, second, third and fourth data tags 222, 224, 226, 228 includes unique information and/or a unique code. Although the example of FIG. 2 illustrates four data tags (e.g., the first, second, third and fourth data tags 222, 224, 226, 228) located on the first, second and third lanes 116, 118, 120 of the roadway 112, each of the first, second and third lanes 116, 118, 120 of the roadway 112 may contain any number of data tags.

In the illustrated example of FIG. 2, each of the first, second, third and fourth data tags 222, 224, 226, 228 contains data that is indicative of and/or associated with a code that is unique to a corresponding one of the first, second or third lanes 116, 118, 120 on which the first, second, third or fourth data tag 222, 224, 226, 228 is located. For example, the first data tag 222 contains data that is indicative of the code 1-0-0, which may in turn be indicative of the first lane 116 of the roadway 112 being the leftmost lane of the roadway 112. The second data tag 224 contains data is indicative of the code 0-1-0, which may in turn be indicative of the second lane 118 of the roadway 112 being the center lane of the roadway 112. The third data tag 226 contains data that is indicative of the code 0-0-1, which may in turn be indicative of the third lane 120 of the roadway 112 being the rightmost lane of the roadway 112. The fourth data tag 228 contains data that is indicative of the code 1-0-1, which may in turn be indicative of the first lane 116 of the roadway 112 being a carpool lane. In other examples, the data contained on the first and fourth data tags 222, 228 may be combined to be contained on a single data tag (e.g., on the first data tag 222).

In the illustrated example of FIG. 2, each of the first, second and third vehicles 102, 104, 106 includes an example onboard navigation system 134. The onboard navigation system 134 is integral to the vehicle, and may form part of and/or otherwise be in communication with a telematics control unit (TCU) (not shown) of the vehicle. As the vehicle travels over the data tags described above, the onboard navigation system 134 reads and/or detects the data and/or codes contained on the data tags. The data and/or code(s) detected and/or read by the onboard navigation system 134 is/are indicative of a specific lane and/or lane type in which the vehicle including the onboard navigation system 134 is traveling.

For example, as the first vehicle 102 of FIG. 2 travels over the first data tag 222, the onboard navigation system 134 of the first vehicle 102 reads and/or detects data contained on the first data tag 222 corresponding to a code (e.g., 1-0-0) associated with the first data tag 222. In some examples, the onboard navigation system 134 of the first vehicle 102 may additionally associate the corresponding code (e.g., 1-0-0) with the first lane 116 of the roadway 112 being the leftmost lane of the roadway 112.

The first vehicle 102 of FIG. 2 may additionally travel over the fourth data tag 228. As the first vehicle 102 travels over the fourth data tag 228, the onboard navigation system 134 of the first vehicle 102 reads and/or detects data contained on the fourth data tag 228 corresponding to a code (e.g., 1-0-1) associated with the fourth data tag 228. In some examples, the onboard navigation system 134 of the first vehicle 102 may additionally associate the corresponding code (e.g., 1-0-1) with the first lane 116 of the roadway 112 being a carpool lane of the roadway 112.

As another example, as the second vehicle 104 of FIG. 2 travels over the second data tag 224, the onboard navigation system 134 of the second vehicle 104 reads and/or detects data contained on the second data tag 224 corresponding to a code (e.g., 0-1-0) associated with the second data tag 224. In some examples, the onboard navigation system 134 of the second vehicle 104 may additionally associate the corresponding code (e.g., 0-1-0) with the second lane 118 of the roadway 112 being the center lane of the roadway 112.

As another example, as the third vehicle 106 of FIG. 2 travels over the third data tag 226, the onboard navigation system 134 of the third vehicle 106 reads and/or detects data contained on the third data tag 226 corresponding to a code (e.g., 0-0-1) associated with the third data tag 226. In some examples, the onboard navigation system 134 of the third vehicle 106 may additionally associate the corresponding code (e.g., 0-0-1) with the third lane 118 of the roadway 112 being the rightmost lane of the roadway 112.

In the illustrated example of FIG. 2, the collection of vehicle travel data, the transmission and/or receipt of vehicle travel data, the generation of lane and vehicle type-specific traffic information, the request for traffic information, the transmission and/or receipt of lane and vehicle type-specific traffic information, and/or the presentation of lane and vehicle type-specific traffic information otherwise occur in a manner that is substantially the same as described above in connection with FIG. 1.

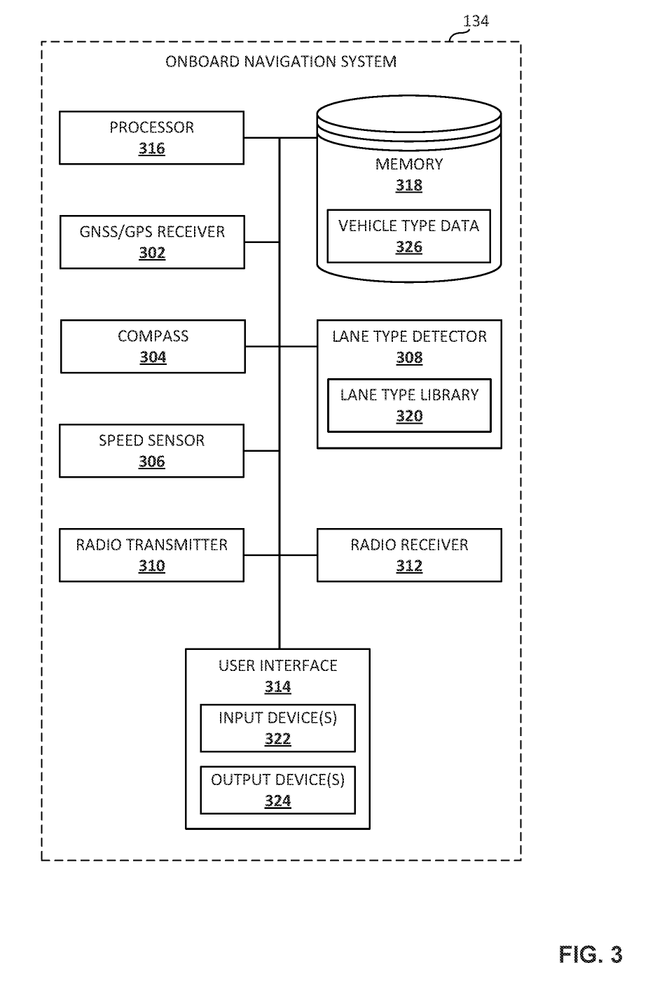

FIG. 3 is a block diagram of the example onboard navigation system 134 of FIGS. 1 and 2 constructed in accordance with the teachings of this disclosure. In the illustrated example of FIG. 3, the onboard navigation system 134 includes an example Global Navigation Satellite System (GNSS)/Global Positioning System (GPS) receiver 302, an example compass 304, an example speed sensor 306, an example lane type detector 308, an example radio transmitter 310, an example radio receiver 312, an example user interface 314, an example processor 316, and an example memory 318. However, other example implementations of the onboard navigation system 134 may include fewer or additional structures in accordance with the teachings of this disclosure.

The example GNSS/GPS receiver 302 of FIG. 3 collects, acquires and/or receives data and/or one or more signal(s) from one or more GNSS satellite(s) (not shown). The data and/or signal(s) received by the GNSS/GPS receiver 302 may include information from which the current position and/or location of a vehicle including the onboard navigation system 134 (e.g., the first vehicle 102 of FIG. 1 including the onboard navigation system 134) may be identified and/or derived, including for example, the current latitude and longitude of the vehicle. Vehicle position data identified and/or derived from the signal(s) collected and/or received by the GNSS/GPS receiver 302 may be associated with one or more time(s) (e.g., time stamped) at which the data and/or signal(s) were collected and/or received by the GNSS/GPS receiver 302. Vehicle position data identified and/or derived from the signal(s) collected and/or received by the GNSS/GPS receiver 302 may be of any type, form and/or format, and may be stored in a computer-readable storage medium such as the example memory 318 described below.

The example compass 304 of FIG. 3 senses, measures and/or detects a direction in which a vehicle including the onboard navigation system 134 (e.g., the first vehicle 102 of FIG. 1 including the onboard navigation system 134) is traveling. Vehicle direction data sensed, measured and/or detected by the compass 304 may be associated with one or more time(s) (e.g., time stamped) at which the data was sensed, measured and/or detected by the compass 304. In some examples, one or more of the time(s) associated with the vehicle direction data may be synchronized with one or more of the time(s) associated with the vehicle position data. Vehicle direction data sensed, measured and/or detected by the compass 304 may be of any type, form and/or format, and may be stored in a computer-readable storage medium such as the example memory 318 described below.

The example speed sensor 306 of FIG. 3 senses, measures and/or detects a speed at which a vehicle including the onboard navigation system 134 (e.g., the first vehicle 102 of FIG. 1 including the onboard navigation system 134) is traveling. In some examples, the speed sensor 306 may be implemented as a vehicle speed sensor (VSS) coupled to the transmission and/or transaxle (not shown) of the vehicle. In other examples, the speed sensor 306 may be implemented as one or more wheel speed sensor(s) (WSS) coupled to one or more corresponding wheel(s) of the vehicle. Vehicle speed data sensed, measured and/or detected by the speed sensor 306 may be associated with one or more time(s) (e.g., time stamped) at which the data was sensed, measured and/or detected by the speed sensor 306. In some examples, one or more of the time(s) associated with the vehicle speed data may be synchronized with one or more of the time(s) associated with the vehicle position data and/or one or more of the time(s) associated with the vehicle direction data. Vehicle speed data sensed, measured and/or detected by the speed sensor 306 may be of any type, form and/or format, and may be stored in a computer-readable storage medium such as the example memory 318 described below.

The example lane type detector 308 of FIG. 3 senses, identifies and/or detects a lane type indicator located on a lane of a roadway. In some examples, the lane type detector 308 may be implemented as a microphone and/or an audio detector circuit that senses, identifies and/or detects one or more sound(s) associated with a vehicle traveling over rumble strips located on a lane or a roadway, as described above in connection with FIG. 1 (e.g., the first vehicle 102 traveling over the first set of rumble strips 122 located on the first lane 116 of the roadway 112 of FIG. 1). In other examples, the lane type detector 308 may be implemented as a reader (e.g., a RFID reader and/or a BLE reader) that senses, identifies, reads and/or detects data (e.g., one or more code(s)) associated with one or more data tag(s) (e.g., RFID tag(s) and/or a BLE tag(s)) located on a lane or a roadway, as described above in connection with FIG. 2 (e.g., the first vehicle 102 traveling over the first data tag 222 located on the first lane 116 of the roadway 112 of FIG. 2).

In some examples, the lane type detector 308 may include an example lane type library 320. The lane type library 320 may correlate and/or associate a code associated with lane type identification data sensed, identified and/or detected by the lane type detector 308 with a specific lane and/or a specific lane type of a roadway. For example, as the first vehicle 102 including the onboard navigation system 134 travels over the first set of rumble strips 122 located on the first lane 116 of the roadway 112 of FIG. 1, or travels over the first data tag 222 located on the first lane 116 of the roadway 112 of FIG. 2, the lane type detector 308 of the onboard navigation system 134 senses, identifies and/or detects the code (1-0-0). The lane type library 320 may correlate and/or associate the code (1-0-0) with the first lane 116 being the leftmost lane of the roadway 112. In a similar manner, the lane type library 320 may correlate and/or associate the code (0-1-0) with the second lane 118 being the center lane of the roadway 112, the code (0-0-1) with the third lane 120 being the rightmost lane of the roadway 112, and the code (1-0-1) with the first lane 116 being a carpool lane of the roadway 112. Based on the correlation(s) and/or association(s) provided by the lane type library 320, the lane type identification data sensed, identified and/or detected by the lane type detector 308 may include a code (e.g., a code such as (1-0-1)) and/or a textual description (e.g., a textual description indicating that the identified lane is a carpool lane). The lane type library 320 of FIG. 3 may be implemented as a table, list, matrix and/or any other structured data format, and may include any number of factors and/or fields. The lane type library 320 is accessible to the lane type detector 308 and/or the example processor 316 of FIG. 3 described below. In some examples, the lane type library 320 may be stored at the example memory 318 described below, or at a remote server such as the example remote server 136 of FIGS. 1, 2 and 4.

Lane type identification data sensed, identified and/or detected by the lane type detector 308 may be associated with one or more time(s) (e.g., time stamped) at which the data was sensed, identified and/or detected by the lane type detector 308. In some examples, one or more of the time(s) associated with the lane type identification data may be synchronized with one or more of the time(s) associated with the vehicle position data, one or more of the time(s) associated with the vehicle direction data, and/or one or more of the time(s) associated with the vehicle speed data. Lane type identification data sensed, identified and/or detected by the lane type detector 308 may be of any type, form and/or format, and may be stored in a computer-readable storage medium such as the example memory 318 described below.

The example radio transmitter 310 of FIG. 3 transmits data and/or one or more signal(s) to the remote server 136 of FIGS. 1, 2 and 4. In some examples, the data and/or signal(s) transmitted by the radio transmitter 310 to the remote server 136 is/are communicated via a network such as the example cellular network 138 of FIGS. 1 and 2. In some examples, the radio transmitter 310 may transmit vehicle travel data including vehicle position data, vehicle direction data, vehicle speed data, vehicle type identification data and/or lane type identification data. In some examples, the radio transmitter 310 may transmit data and/or signal(s) corresponding to one or more request(s) for traffic information. In some examples, the request includes the current position and/or location of the onboard navigation system 134. Data corresponding to the signal(s) to be transmitted by the radio transmitter 310 may be of any type, form and/or format, and may be stored in a computer-readable storage medium such as the example memory 318 described below.

The example radio receiver 312 of FIG. 3 collects, acquires and/or receives data and/or one or more signal(s) from the remote server 136 of FIGS. 1, 2 and 4. In some examples, the data and/or signal(s) received by the radio receiver 312 from the remote server 136 is/are communicated via a network such as the example cellular network 138 of FIGS. 1 and 2. In some examples, the radio receiver 312 may receive data and/or signal(s) corresponding to lane and vehicle type-specific traffic information. Data identified and/or derived from the signal(s) collected and/or received by the radio receiver 312 may be of any type, form and/or format, and may be stored in a computer-readable storage medium such as the example memory 318 described below.

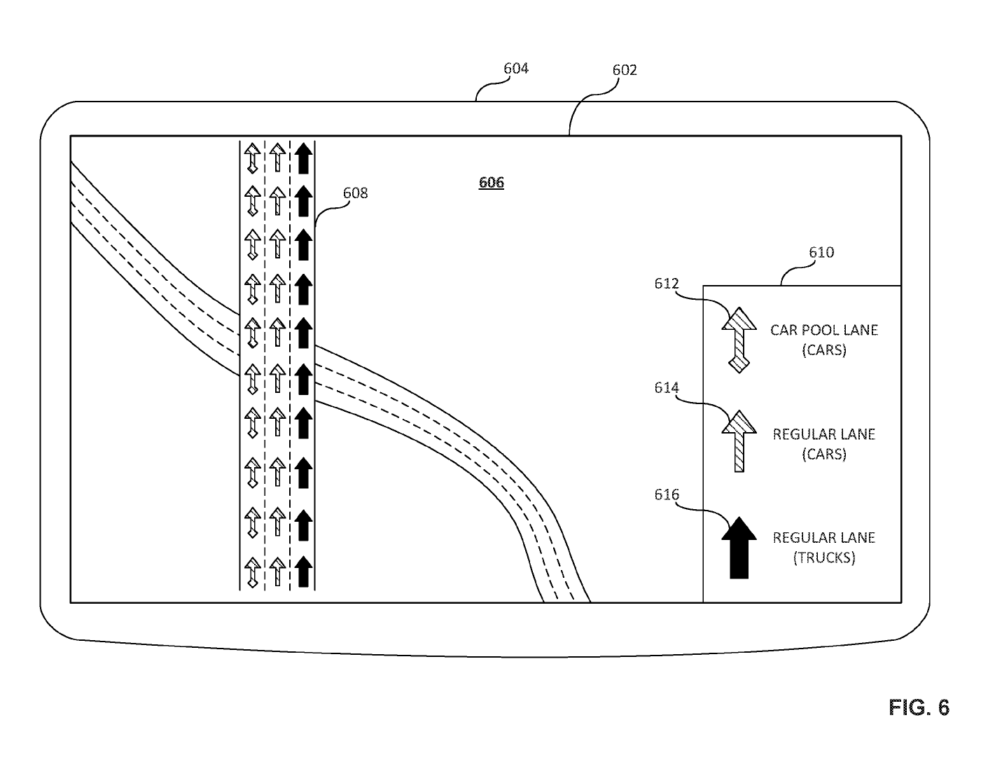

The example user interface 314 of FIG. 3 facilitates interactions and/or communications between an end user and the onboard navigation system 134. The user interface 314 includes one or more input device(s) 322 via which the user may input information and/or data to the onboard navigation system 134. For example, the user interface 314 may be a button, a microphone, and/or a touchscreen that enable(s) the user to convey data and/or commands to the onboard navigation system 134. As further described below in connection with FIG. 6, the input device(s) 322 of the user interface 314 may enable an end user to request lane and vehicle type-specific traffic information to be presented via the user interface 314, and/or to filter lane and vehicle type-specific traffic information being presented and/or to be presented via the user interface 314.

The user interface 314 of FIG. 3 also includes one or more output device(s) 324 via which the processor 316 of the onboard navigation system 134 presents information and/or data in visual and/or audible form to the user. For example, the user interface 314 may include a light emitting diode, a touchscreen, and/or a liquid crystal display for presenting visual information, and/or a speaker for presenting audible information. As further described below in connection with FIG. 6, lane and vehicle type-specific traffic information may be presented via the output device(s) 324 of the user interface 314. Data and/or information that is presented and/or received via the user interface 314 may be of any type, form and/or format, and may be stored in a computer-readable storage medium such as the example memory 318 described below.

The example processor 316 of FIG. 3 may be implemented by a semiconductor device such as a microprocessor, controller or microcontroller. The processor 316 manages and/or controls the operation of the onboard navigation system 134 based on data, information and/or one or more signal(s) obtained and/or accessed by the processor 316 from one or more of the GNSS/GPS receiver 302, the compass 304, the speed sensor 306, the lane type detector 308, the radio receiver 312, the user interface 314 and/or the memory 318, and/or based on data, information and/or one or more signal(s) provided by the processor 316 to one or more of the radio transmitter 310 and/or the user interface 314.

In some examples, the processor 316 of FIG. 3 determines a vehicle type of the vehicle. For example, the memory 318 of FIG. 3 may include vehicle type identification data 326 that is accessible to the processor 316. The vehicle type identification data 326 corresponds to and/or identifies the vehicle type (e.g., a car, a truck, etc.) of the vehicle. For example, the vehicle type identification data 326 of the onboard navigation system 134 of the first vehicle 102 of FIG. 1 may indicate that the first vehicle 102 is a car. In some examples, the vehicle type identification data 326 may be represented by a code that the processor 316 may correlate with a specific type of vehicle. For example, the processor 316 may determine that vehicle type identification data 326 having a code of (A) is indicative of the vehicle being a car, that vehicle type identification data 326 having a code of (B) is indicative of the vehicle being a truck, and so on. The processor 316 may access, obtain, and/or otherwise identify the vehicle type identification data 326 from the memory 318 described below.

In some examples, the processor 316 of FIG. 3 determines a position of the vehicle. For example, the processor 316 may access, obtain and/or otherwise identify the vehicle position data identified and/or derived from the signal(s) collected and/or received by the GNSS/GPS receiver 302. The vehicle position data accessed, obtained and/or otherwise identified by the processor 316 may include timing information (e.g., time stamps) corresponding to times at which the vehicle position data was collected and/or received by the GNSS/GPS receiver 302. The processor 316 may access, obtain and/or otherwise identify such vehicle position data from the GNSS/GPS receiver 302 and/or from the example memory 318 described below.

In some examples, the processor 316 of FIG. 3 determines a direction of the vehicle. For example, the processor 316 may access, obtain and/or otherwise identify the vehicle direction data sensed, measured and/or detected by the compass 304. The vehicle direction data accessed, obtained and/or otherwise identified by the processor 316 may include timing information (e.g., time stamps) corresponding to times at which the vehicle direction data was sensed, measured and/or detected by the compass 304. The processor 316 may access, obtain and/or otherwise identify such vehicle direction data from the compass 304 and/or from the example memory 318 described below.

In some examples, the processor 316 of FIG. 3 determines a speed of the vehicle. For example, the processor 316 may access, obtain and/or otherwise identify the vehicle speed data sensed, measured and/or detected by the speed sensor 306. The vehicle speed data accessed, obtained and/or otherwise identified by the processor 316 may include timing information (e.g., time stamps) corresponding to times at which the vehicle speed data was sensed, measured and/or detected by the speed sensor 306. The processor 316 may access, obtain and/or otherwise identify such vehicle speed data from the speed sensor 306 and/or from the example memory 318 described below.

In some examples, the processor 316 of FIG. 3 determines a lane type of the vehicle. For example, the processor 316 may access, obtain, and/or otherwise identify lane type identification data sensed, identified and/or detected by the lane type detector 308. In some examples, the lane type identification data accessed, obtained, and/or otherwise identified by the processor 316 may include date sensed, identified and/or detected by the lane type detector 308 in conjunction with the lane type library 320 of FIG. 3. The lane type identification data accessed, obtained and/or otherwise identified by the processor 316 may include timing information (e.g., time stamps) corresponding to times at which the lane type identification data was sensed, identified and/or detected by the lane type detector 308. The processor 316 may access, obtain and/or otherwise identify such lane type identification data from the lane type detector 308 and/or from the example memory 318 described below.

In some examples, the processor 316 of FIG. 3 generates vehicle travel data based on the vehicle position data, the vehicle direction data, the vehicle speed data, the vehicle type identification data, and the lane type identification data. In some examples, the vehicle travel data is synchronized and/or otherwise organized based on the timing information associated with each of the vehicle position data, the vehicle direction data, the vehicle speed data, and the lane type identification data. For example, first data and/or first data point of the vehicle travel data may include a position of the vehicle at a first time, a direction of the vehicle at the first time, a speed of the vehicle at the first time, and a lane type corresponding to a lane in which the vehicle was traveling at the first time. Second data and/or second data point of the vehicle travel data may include a position of the vehicle at a second time subsequent to the first time, a direction of the vehicle at the second time, a speed of the vehicle at the second time, and a lane type corresponding to a lane in which the vehicle was traveling at the second time. One or more of the first and/or second data and/or the first and/or second data point(s) may also include the vehicle type identification data corresponding to the vehicle. Vehicle travel data generated and/or determined by the processor 316 may be of any type, form and/or format, and may be stored in a computer-readable storage medium such as the example memory 318 described below.

In some examples, the processor 316 of FIG. 3 determines whether the vehicle travel data for the vehicle is to be transmitted. For example, the processor 316 may receive one or more command(s) and or instruction(s) indicating that the vehicle travel data for the vehicle is to be transmitted to the remote server 136 of FIGS. 1, 2 and 4. In some examples, such command(s) and/or instruction(s) may be predetermined and/or otherwise defined by an application and/or program executing on the onboard navigation system 134. In other examples, such command(s) and/or instruction(s) may be associated with one or more user input(s) received via the input device(s) 322 of the user interface 314 of FIG. 3. If the processor 316 determines that the vehicle travel data for the vehicle is to be transmitted, the processor 316 provides one or more control signal(s) and/or instruction(s) to the radio transmitter 310 of FIG. 3 instructing the radio transmitter 310 to transmit the vehicle travel data. In response to such signal(s) and/or instruction(s), the radio transmitter 310 may transmit the vehicle travel data.

In some examples, the processor 316 of FIG. 3 determines whether vehicle travel data for the vehicle is to continue being collected. For example, the processor 316 may receive one or more command(s) and or instruction(s) indicating that vehicle travel data for the vehicle is not to continue being collected. In some examples, such command(s) and/or instruction(s) may be predetermined and/or otherwise defined by an application and/or program executing on the onboard navigation system 134. In other examples, such command(s) and/or instruction(s) may be associated with one or more user input(s) received via the input device(s) 322 of the user interface 314 of FIG. 3. If the processor 316 determines that vehicle travel data for the vehicle is not to continue being collected, the processor 316 may provide one or more control signal(s) and/or instruction(s) to one or more of the GNSS/GPS receiver 302, the compass 304, the speed sensor 306, the lane type detector 308 and/or the user interface 314 of FIG. 3 indicating that vehicle travel data for the vehicle is not to continue being collected. In response to such signal(s) and/or instruction(s), one or more of the GNSS/GPS receiver 302, the compass 304, the speed sensor 306, the lane type detector 308 and/or the user interface 314 of FIG. 3 may cease sensing, measuring, collecting and/or detecting data associated with vehicle travel data for the vehicle. In some examples, the processor 316 determines that vehicle travel data for the vehicle is to continue being collected, generated and/or transmitted on a periodic basis (e.g., according to a predetermined frequency and/or in response to the occurrence of a predetermined event).

In some examples, the processor 316 of FIG. 3 instructs the radio transmitter 310 of FIG. 3 to transmit a request for traffic information (e.g., a request for lane and vehicle type-specific traffic information). For example, the processor 316 may provide one or more command(s) and/or instruction(s) to the radio transmitter 310 instructing the radio transmitter 310 to transmit one or more request(s) for traffic information to the remote server 136 of FIGS. 1, 2 and 4. In some examples, such command(s) and/or instruction(s) may be predetermined and/or otherwise defined by an application and/or program executing on the onboard navigation system 134. In other examples, such command(s) and/or instruction(s) may be associated with one or more user input(s) received via the input device(s) 322 of the user interface 314 of FIG. 3. In response to such command(s) and/or instruction(s), the radio transmitter 310 may transmit one or more request(s) for traffic information.

In some examples, the processor 316 of FIG. 3 instructs the user interface 314 of FIG. 3 to present lane and vehicle type-specific traffic information. For example, the processor 316 may provide one or more command(s) and/or instruction(s) to the user interface 314 instructing the user interface 314 to present the lane and vehicle type-specific traffic information received from the remote server 136 of FIGS. 1, 2 and 4. In some examples, such command(s) and/or instruction(s) may be predetermined and/or otherwise defined by an application and/or program executing on the onboard navigation system 134. In other examples, such command(s) and/or instruction(s) may be associated with one or more user input(s) received via the input device(s) 322 of the user interface 314 of FIG. 3. In response to such command(s) and/or instruction(s), the user interface 314 may present the lane and vehicle type-specific traffic information. An example of lane and vehicle type-specific traffic information presented via the user interface 314 of FIG. 3 is further described below in connection with FIG. 6.

In some examples, the processor 316 of FIG. 3 determines whether to filter the lane and vehicle type-specific traffic information being presented and/or to be presented via the user interface 314 of FIG. 3. For example, the processor 316 may receive one or more command(s) and/or instruction(s) indicating that the lane and vehicle type-specific information is to be filtered based on one or more vehicle type(s) and/or lane type(s). As one example, the command(s) and/or instruction(s) may indicate that the lane and vehicle type-specific traffic information is to be filtered to remove and/or mask one or more portion(s) of the lane and vehicle type-specific information associated with vehicle types other than cars. As another example, the command(s) and/or instruction(s) may indicate that the lane and vehicle type-specific traffic information is to be filtered to remove and/or mask one or more portion(s) of the lane and vehicle type-specific information associated with lane types other than carpool lanes. In some examples, the command(s) and/or instruction(s) received by the processor 316 may be predetermined and/or otherwise defined by an application and/or program executing on the onboard navigation system 134. In other examples, such command(s) and/or instruction(s) may be associated with one or more user input(s) received via the input device(s) 322 of the user interface 314 of FIG. 3.

In some examples, the processor 316 of FIG. 3 filters, and/or instructs the user interface 314 of FIG. 3 to filter, the lane and vehicle type-specific traffic information being presented and/or to be presented via the user interface 314 of FIG. 3. For example, the processor 316 and/or the user interface 314 may filter the lane and vehicle type-specific traffic information by removing and/or masking one or more portion(s) of the lane and vehicle type-specific traffic information corresponding to one or more vehicle type(s) and/or lane type(s). As one example, the processor 316 and/or the user interface 314 may remove and/or mask one or more portion(s) of the lane and vehicle type-specific traffic information associated with vehicle types other than cars. As another example, the processor 316 and/or the user interface 314 may remove and/or mask one or more portion(s) of the lane and vehicle type-specific traffic information associated with lane types other than carpool lanes.

In some examples, the processor 316 of FIG. 3 generates a route to be followed by a vehicle based on a vehicle type of the vehicle and/or a lane type for travel of the vehicle, and further based on the lane and vehicle type-specific traffic information. For example, the processor 316 may generate a first route for a vehicle that is a car that will be traveling in a carpool lane. The first route may be based on a first portion of the lane and vehicle type-specific traffic information corresponding to the identified vehicle type (e.g., a car) and/or the identified lane type (e.g., a carpool lane). As another example, the processor 316 may generate a second route for a vehicle that is a car that will be traveling in a regular lane. The second route may be based on a second portion of the lane and vehicle type-specific traffic information corresponding to the identified vehicle type (e.g., a car) and/or the identified lane type (e.g., a regular lane). As another example, the processor 316 may generate a third route for a vehicle that is a truck that will be traveling in a regular lane. The third route may be based on a third portion of the lane and vehicle type-specific traffic information corresponding to the identified vehicle type (e.g., a truck) and/or the identified lane type (e.g., a regular lane). Thus, in examples where a car and a truck may be traveling from a common origin to a common destination, the processor 316 may generate different routes for the car and the truck (e.g., a first route for the car and a second, different route for the truck) based on the respective vehicle type of the two vehicles (e.g., car versus truck) and/or based on the respective lane type associated with the two vehicles (e.g., carpool lane versus regular lane).

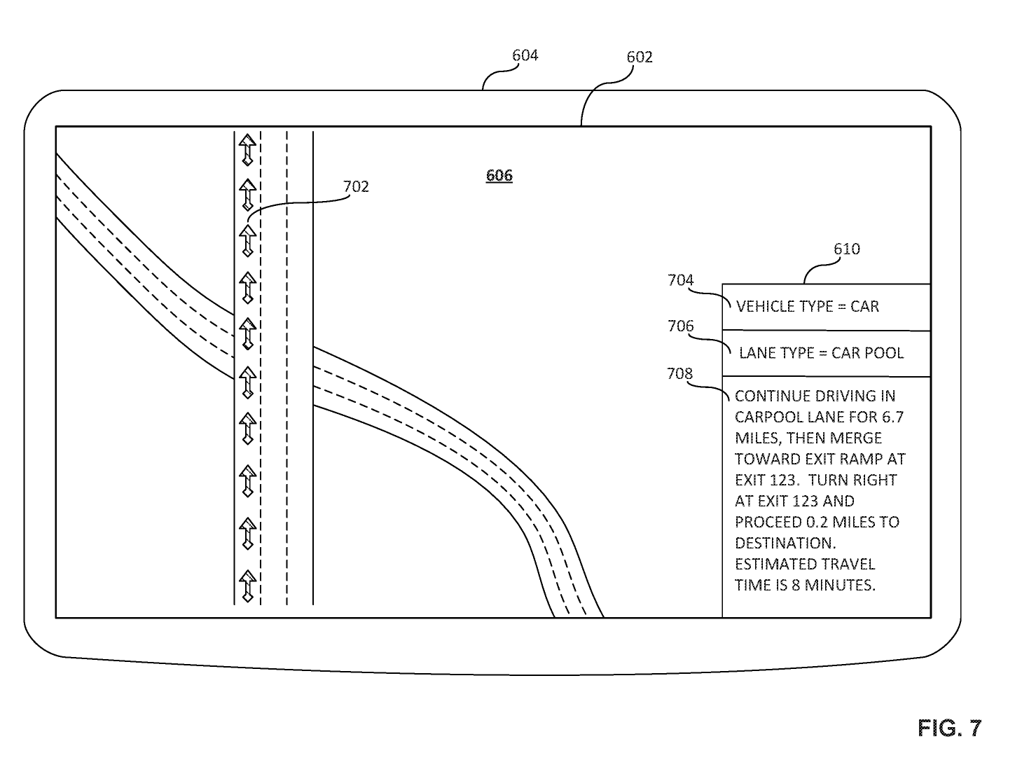

In some examples, the processor 316 of FIG. 3 instructs the user interface 314 of FIG. 3 to present a route based on a vehicle type and/or a lane type of a vehicle and based on the lane and vehicle type-specific traffic information. For example, the processor 316 may provide one or more command(s) and/or instruction(s) to the user interface 314 instructing the user interface 314 to present the route generated by the processor 316. In some examples, such command(s) and/or instruction(s) may be predetermined and/or otherwise defined by an application and/or program executing on the onboard navigation system 134. In other examples, such command(s) and/or instruction(s) may be associated with one or more user input(s) received via the input device(s) 322 of the user interface 314 of FIG. 3. In response to such command(s) and/or instruction(s), the user interface 314 may present the route. An example route presented via the user interface 314 of FIG. 3 is further described below in connection with FIG. 7.

In some examples, the processor 316 of FIG. 3 determines whether lane and vehicle type-specific traffic information and/or a route is to continue being presented via the example user interface 314 of FIG. 3. For example, the processor 316 may receive one or more command(s) and or instruction(s) indicating that lane and vehicle type-specific traffic information and/or a route is not to continue being presented. In some examples, such command(s) and/or instruction(s) may be predetermined and/or otherwise defined by an application and/or program executing on the onboard navigation system 134. In other examples, such command(s) and/or instruction(s) may be associated with one or more user input(s) received via the input device(s) 322 of the user interface 314 of FIG. 3. If the processor 316 determines that lane and vehicle type-specific traffic information and/or a route is not to continue being presented, the processor 316 may provide one or more control signal(s) and/or instruction(s) to the user interface 314 of FIG. 3 indicating that lane and vehicle type-specific traffic information and/or the route is not to continue being presented. In response to such signal(s) and/or instruction(s), the user interface 314 may cease presenting the lane and vehicle type-specific traffic information and/or the route.

The example memory 318 of FIG. 3 may be implemented by any type(s) and/or any number(s) of storage device(s) such as a storage drive, a flash memory, a read-only memory (ROM), a random-access memory (RAM), a cache and/or any other storage medium in which information is stored for any duration (e.g., for extended time periods, permanently, brief instances, for temporarily buffering, and/or for caching of the information). The information stored in the memory 318 may be stored in any file and/or data structure format, organization scheme, and/or arrangement. In some examples, the memory 318 stores vehicle position data collected, received, identified and/or derived by the GNSS/GPS receiver 302, vehicle direction data sensed, measured and/or detected by the compass 304, vehicle speed data sensed, measured and/or detected by the speed sensor 306, lane type identification data sensed, identified and/or detected by the lane type detector 308, vehicle type identification data 326, vehicle travel data to be transmitted by the radio transmitter 310, lane and vehicle type-specific traffic information collected and/or received by the radio receiver 312, and/or lane and vehicle type-specific traffic information to be presented via the user interface 314. The memory 318 is accessible to the example GNSS/GPS receiver 302, the example compass 304, the example speed sensor 306, the example lane type detector 308, the example radio transmitter 310, the example radio receiver 312, the example user interface 314, and the example processor 316 of FIG. 3, and/or, more generally, to the example onboard navigation system 134 of FIGS. 1-3.

While an example manner of implementing the example onboard navigation system 134 is illustrated in FIG. 3, one or more of the elements, processes and/or devices illustrated in FIG. 3 may be combined, divided, re-arranged, omitted, eliminated and/or implemented in any other way. Further, the example GNSS/GPS receiver 302, the example compass 304, the example speed sensor 306, the example lane type detector 308, the example radio transmitter 310, the example radio receiver 312, the example user interface 314, the example processor 316 and/or the example memory 318 of FIG. 3 may be implemented by hardware, software, firmware and/or any combination of hardware, software and/or firmware. Thus, for example, any of the example GNSS/GPS receiver 302, the example compass 304, the example speed sensor 306, the example lane type detector 308, the example radio transmitter 310, the example radio receiver 312, the example user interface 314, the example processor 316 and/or the example memory 318 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example GNSS/GPS receiver 302, the example compass 304, the example speed sensor 306, the example lane type detector 308, the example radio transmitter 310, the example radio receiver 312, the example user interface 314, the example processor 316 and/or the example memory 318 is/are hereby expressly defined to include a tangible computer readable storage device or storage disk such as a memory, a digital versatile disk (DVD), a compact disk (CD), a Blu-ray disk, etc. storing the software and/or firmware. Further still, the example onboard navigation system 134 of FIG. 3 may include one or more elements, processes and/or devices in addition to, or instead of, those illustrated in FIG. 3, and/or may include more than one of any or all of the illustrated elements, processes and devices.

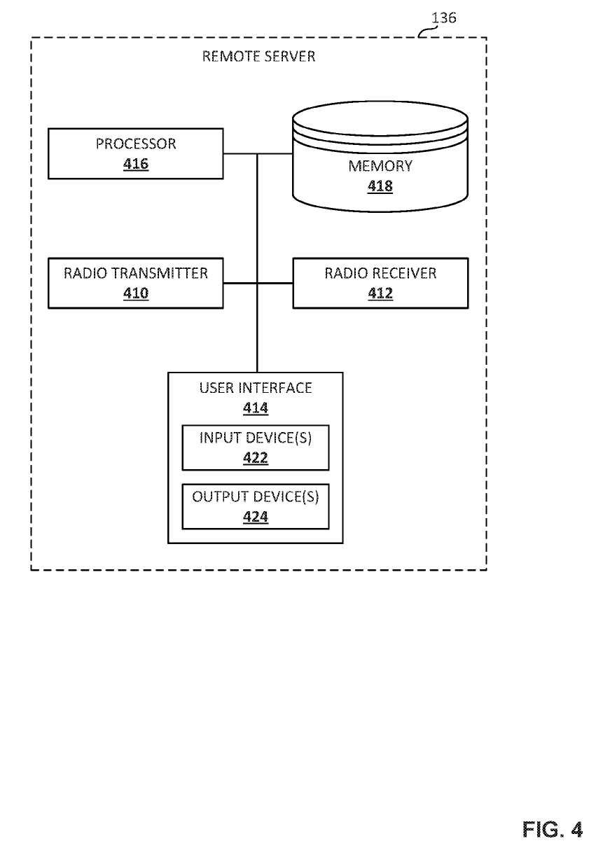

FIG. 4 is a block diagram of the example remote server 136 of FIGS. 1 and 2 constructed in accordance with the teachings of this disclosure. In the illustrated example of FIG. 4, the remote server 136 includes an example radio transmitter 410, an example radio receiver 412, an example user interface 414, an example processor 416, and an example memory 418. However, other example implementations of the remote server 136 may include fewer or additional structures in accordance with the teachings of this disclosure. For example, in instances where the remote server 136 of FIGS. 1, 2 and 4 is in wired communication with the example cellular network 138 of FIGS. 1 and 2, the remote server 136 may transmit and/or receive data, information and/or signal(s) without utilizing a radio transmitter and/or a radio receiver. In such examples, one or both of the example radio transmitter 410 and/or the example radio receiver 412 of FIG. 4 described herein may be omitted from the remote server 136, and the function(s) of one or both of the example radio transmitter 410 and/or the example radio receiver 412 of FIG. 4 may instead be performed at the direction of the example processor 416 of the remote server 136 of FIG. 4 via the wired connection between the remote server 136 and the cellular network 138.

The example radio transmitter 410 of FIG. 4 and/or the remote server 136 of FIGS. 1, 2 and 4 transmits data and/or one or more signal(s) to the onboard navigation system 134 of FIGS. 1-3 and/or to the mobile device 140 of FIGS. 1, 2 and 5. In some examples, the data and/or signal(s) transmitted by the radio transmitter 410 and/or the remote server 136 to the onboard navigation system 134 and/or to the mobile device 140 are communicated via a cellular network such as the example cellular network 138 of FIGS. 1 and 2. In some examples, the radio transmitter 410 and/or the remote server 136 may transmit data and/or signal(s) corresponding to lane and vehicle type-specific traffic information. Data corresponding to the signal(s) to be transmitted by the radio transmitter 410 and/or the remote server 136 may be of any type, form and/or format, and may be stored in a computer-readable storage medium such as the example memory 418 described below.

The example radio receiver 412 of FIG. 4 and/or the remote server 136 of FIGS. 1, 2 and 4 collects, acquires and/or receives data and/or one or more signal(s) from the onboard navigation system 134 of FIGS. 1-3 and/or from the mobile device 140 of FIGS. 1, 2 and 5. In some examples, the data and/or signal(s) received by the radio receiver 412 and/or the remote server 136 from the onboard navigation system 134 and/or from the mobile device 140 are communicated via a cellular network such as the example cellular network 138 of FIGS. 1 and 2. In some examples, the radio receiver 412 and/or the remote server 136 may receive vehicle travel data from one or more vehicle(s) having onboard navigation systems such as the example onboard navigation system 134 of FIGS. 1-3. In some examples, the vehicle travel data may include vehicle position data, vehicle direction data, vehicle speed data, vehicle type identification data and/or lane type identification data. In some examples, the radio receiver 412 and/or the remote server 136 may receive data and/or signal(s) from the onboard navigation system 134 and/or from the mobile device 140 corresponding to one or more request(s) for traffic information. Data identified and/or derived from the signal(s) collected and/or received by the radio receiver 412 and/or the remote server 136 may be of any type, form and/or format, and may be stored in a computer-readable storage medium such as the example memory 418 described below.

The example user interface 414 of FIG. 4 facilitates interactions and/or communications between an end user and the remote server 136. The user interface 414 includes one or more input device(s) 422 via which the user may input information and/or data to the remote server 136. For example, the user interface 414 may be a button, a microphone, and/or a touchscreen that enable(s) the user to convey data and/or commands to the remote server 136. The user interface 414 also includes one or more output device(s) 424 via which the processor 416 of the remote server 136 presents information and/or data in visual and/or audible form to the user. For example, the user interface 414 may include a light emitting diode, a touchscreen, and/or a liquid crystal display for presenting visual information, and/or a speaker for presenting audible information. Lane and vehicle type-specific traffic information generated by the remote server 136 may be presented via the output device(s) 324 of the user interface 314. Data and/or information that is presented and/or received via the user interface 414 may be of any type, form and/or format, and may be stored in a computer-readable storage medium such as the example memory 418 described below.

The example processor 416 of FIG. 4 may be implemented by a semiconductor device such as a microprocessor, controller or microcontroller. The processor 416 manages and/or controls the operation of the remote server 136 based on data, information and/or one or more signal(s) obtained and/or accessed by the processor 416 from one or more of the radio receiver 412, the user interface 414 and/or the memory 418, and/or based on data, information and/or one or more signal(s) provided by the processor 416 to one or more of the radio transmitter 410 and/or the user interface 414.

In some examples, the processor 416 of FIG. 4 groups and/or otherwise associates various packets of vehicle travel data received at the remote server 136 of FIGS. 1, 2 and 4 based on the vehicle type identification data included in each packet of vehicle travel data. For example, the processor 416 may group together packets of vehicle travel data commonly having vehicle type identification data indicative of a vehicle type corresponding to a car. As another example, the processor 416 may group together packets of vehicle travel data commonly having vehicle type identification data indicative of a vehicle type corresponding to a truck. Packets of vehicle travel data to be grouped by the processor 416 may be transmitted to the remote server 136 by vehicles having onboard navigation systems 134 such as, for example, the first, second, third and fourth vehicles 102, 104, 106, 108 of FIGS. 1 and 2.

In some examples, the processor 416 of FIG. 4 groups and/or otherwise associates various packets of vehicle travel data received at the remote server 136 of FIGS. 1, 2 and 4 based on the lane type identification data included in each packet of vehicle travel data. For example, the processor 416 may group together packets of vehicle travel data commonly having lane type identification data indicative of a lane type corresponding to a carpool lane. As another example, the processor 416 may group together packets of vehicle travel data commonly having lane type identification data indicative of a lane type corresponding to a regular lane. Packets of vehicle travel data to be grouped by the processor 416 may be transmitted to the remote server 136 by vehicles having onboard navigation systems 134 such as, for example, the first, second, third and fourth vehicles 102, 104, 106, 108 of FIGS. 1 and 2.

In some examples, the processor 416 of FIG. 4 may group and/or otherwise associate various packets of vehicle travel data based on lane type identification data after the processor 416 of FIG. 4 has already grouped and/or associated the packets of vehicle travel data based on vehicle type identification data. In other examples, the processor 416 of FIG. 4 may group and/or otherwise associate various packets of vehicle travel data based on vehicle type identification data after the processor 416 of FIG. 4 has already grouped and/or associated the packets of vehicle travel data based on lane type identification data. In such examples, the groupings and/or associations provided by the processor 416 are lane and vehicle type-specific. For example, a first grouping of vehicle travel data provided by the processor 416 may be limited to cars traveling in carpool lanes, a second grouping of vehicle travel data provided by the processor 416 may be limited to trucks traveling in regular lanes, etc.

In some examples, the processor 416 of FIG. 4 generates lane and vehicle type-specific traffic information. For example, the processor 416 may generate lane and vehicle type-specific traffic information by determining, for one or more segment(s) of a roadway (e.g., a specific length and/or area of a roadway), an average vehicle speed of one or more vehicle(s) represented by each grouping and/or association of vehicle travel data provided by the processor 416. The processor 416 may assign and/or append codes, textual descriptors and/or graphics to each grouping and/or association such that the traffic information for each grouping and/or association within the lane and vehicle type-specific traffic information is unique and/or distinguishable when presented on a user interface. For example, the processor 416 may configure the lane and vehicle type-specific traffic information such that different portions of the traffic information corresponding to the different groupings and/or associations of vehicle travel data provided by the processor 416 include and/or are associated with graphics that, when presented on a user interface of an electronic device (e.g., the user interface 314 of the onboard navigation system 134 of FIGS. 1-3 or the user interface 514 of the mobile device 140 of FIGS. 1, 2 and 5), enable an end user to distinguish a first portion of the lane and vehicle type-specific traffic information (e.g., cars traveling in a carpool lane) from a second portion of the lane and vehicle type-specific traffic information (e.g., cars traveling in a regular lane) and/or from a third portion of the lane and vehicle type-specific traffic information (e.g., trucks traveling in a regular lane).

In some examples, the processor 416 of FIG. 4, in conjunction with generating the lane and vehicle type-specific traffic information, may configure the lane and vehicle type-specific traffic information to be graphically displayed on, as part of, and/or in conjunction with a map representing one or more segment(s) of a roadway (e.g., a specific length and/or area of a roadway) to which the lane and vehicle type-specific traffic information pertains. The processor 416 may further configure the lane and vehicle type-specific traffic information and/or the map to include a map legend having one or more description(s) and/or indication(s) associated with one or more graphic(s) and/or icon(s) representing one or more portion(s) of the lane and vehicle type-specific traffic information when presented.

For example, the lane and vehicle type-specific traffic information generated by the processor 416 may include coding (e.g., one or more graphic(s)) that provides an indication of particular portions represented by the lane and vehicle type-specific traffic information. As one example, the processor 416 may configure a first portion of the lane and vehicle type-specific traffic information to be graphically represented by a first graphic having a first line thickness, a first symbol and a first color. The first line thickness may be indicative of traffic for cars, the first symbol may be indicative of a carpool lane, and the first color may be indicative of low density (e.g., clear and/or fast moving) traffic. As another example, the processor 416 may configure a second portion of the lane and vehicle type-specific traffic information to be graphically represented by a second graphic having a second line thickness, a second symbol and a second color. The second line thickness may be indicative of traffic for cars, the second symbol may be indicative of a regular lane, and the second color may be indicative of low density (e.g., clear and/or fast moving) traffic. As another example, the processor 416 may configure a third portion of the lane and vehicle type-specific traffic information to be graphically represented by a third graphic having a third line thickness, a third symbol and a third color. The third line thickness may be indicative of traffic for trucks, the third symbol may be indicative of a regular lane, and the third color may be indicative of high density (e.g., heavy and/or slow moving) traffic. In such examples, the map legend configured by the processor 416 in connection with generating the lane and vehicle type-specific traffic information may include one or more description(s) and/or indication(s) corresponding to one or more of the first, second and/or third graphic(s). An example of lane and vehicle type-specific traffic information generated by the processor 416 of FIG. 4 and presented on a map via a user interface of an electronic device (e.g., the user interface 314 of the onboard navigation system 134 of FIGS. 1-3 or the user interface 514 of the mobile device 140 of FIGS. 1, 2 and 5) is further described below in connection with FIG. 6.

In some examples, the processor 416 of FIG. 4 determines whether a request for traffic information has been received at the remote server 136 of FIGS. 1, 2 and 4. For example, the processor 416 may receive one or more command(s) and or instruction(s) indicating that the radio receiver 412 of FIG. 4 and/or the remote server 136 of FIGS. 1, 2 and 4 has received a request for traffic information via the cellular network 138 of FIGS. 1 and 2. In some examples, such command(s) and/or instruction(s) may be predetermined and/or otherwise defined by an application and/or program executing on the remote server 136. If the processor 416 determines that the a request for traffic information has been received, the processor 416 provides one or more control signal(s) and/or instruction(s) to the radio transmitter 410 of FIG. 4 and/or the remote server 136 instructing the radio transmitter 410 and/or the remote server 136 to transmit the lane and vehicle type-specific traffic information generated by the processor 416 and/or stored in the example memory 418 described below. In response to such signal(s) and/or instruction(s), the radio transmitter 410 and/or the remote server 136 may transmit the lane and vehicle type-specific traffic information via the cellular network 138 to an onboard navigation system (e.g., the onboard navigations system 134 of FIGS. 1-3) and/or a mobile device (e.g., the mobile device 140 of FIGS. 1, 2 and 5). In some examples, the transmitted lane and vehicle type-specific traffic information may be tailored to the current position and/or location of the onboard navigation system and/or of the mobile device.

In some examples, the processor 416 of FIG. 4 determines whether to continue generating lane and vehicle type-specific traffic information. For example, the processor 416 may receive one or more command(s) and or instruction(s) indicating that lane and vehicle type-specific traffic information is not to continue being generated. In some examples, such command(s) and/or instruction(s) may be predetermined and/or otherwise defined by an application and/or program executing on the remote server 136. In other examples, such command(s) and/or instruction(s) may be associated with one or more user input(s) received via the input device(s) 422 of the user interface 414 of FIG. 4. If the processor 416 determines that lane and vehicle type-specific traffic information is not to continue being generated, the processor 416 may cease generating the lane and vehicle type-specific traffic information. In some examples, the processor 416 may determine that lane and vehicle type-specific traffic information is to continue being generated and/or transmitted on a periodic basis (e.g., according to a predetermined frequency and/or in response to the occurrence of a predetermined event).

The example memory 418 of FIG. 4 may be implemented by any type(s) and/or any number(s) of storage device(s) such as a storage drive, a flash memory, a read-only memory (ROM), a random-access memory (RAM), a cache and/or any other storage medium in which information is stored for any duration (e.g., for extended time periods, permanently, brief instances, for temporarily buffering, and/or for caching of the information). The information stored in the memory 418 may be stored in any file and/or data structure format, organization scheme, and/or arrangement. In some examples, the memory 418 stores vehicle position data received by the radio receiver 412 and/or the remote server 136 from various vehicles, vehicle direction data received by the radio receiver 412 and/or the remote server 136 from various vehicles, vehicle speed data received by the radio receiver 412 and/or the remote server 136 from various vehicles, lane type identification data received by the radio receiver 412 and/or the remote server 136 from various vehicles, vehicle type identification data received by the radio receiver 412 and/or the remote server 136 from various vehicles, vehicle travel data received by the radio receiver 412 and/or the remote server 136 from various vehicles, lane and vehicle type-specific traffic information generated by the processor 416, and/or lane and vehicle type-specific traffic information to be transmitted by the radio transmitter 410 and/or the remote server 136. The memory 418 is accessible to the example radio transmitter 410, the example radio receiver 412, the example user interface 414, and the example processor 416 of FIG. 4, and/or, more generally, to the example remote server 136 of FIGS. 1, 2 and 4.

While an example manner of implementing the example remote server 136 is illustrated in FIG. 4, one or more of the elements, processes and/or devices illustrated in FIG. 4 may be combined, divided, re-arranged, omitted, eliminated and/or implemented in any other way. Further, the example radio transmitter 410, the example radio receiver 412, the example user interface 414, the example processor 416 and/or the example memory 418 of FIG. 4 may be implemented by hardware, software, firmware and/or any combination of hardware, software and/or firmware. Thus, for example, any of the example radio transmitter 410, the example radio receiver 412, the example user interface 414, the example processor 416 and/or the example memory 418 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example radio transmitter 410, the example radio receiver 412, the example user interface 414, the example processor 416 and/or the example memory 418 is/are hereby expressly defined to include a tangible computer readable storage device or storage disk such as a memory, a digital versatile disk (DVD), a compact disk (CD), a Blu-ray disk, etc. storing the software and/or firmware. Further still, the example remote server 136 of FIG. 4 may include one or more elements, processes and/or devices in addition to, or instead of, those illustrated in FIG. 4, and/or may include more than one of any or all of the illustrated elements, processes and devices.

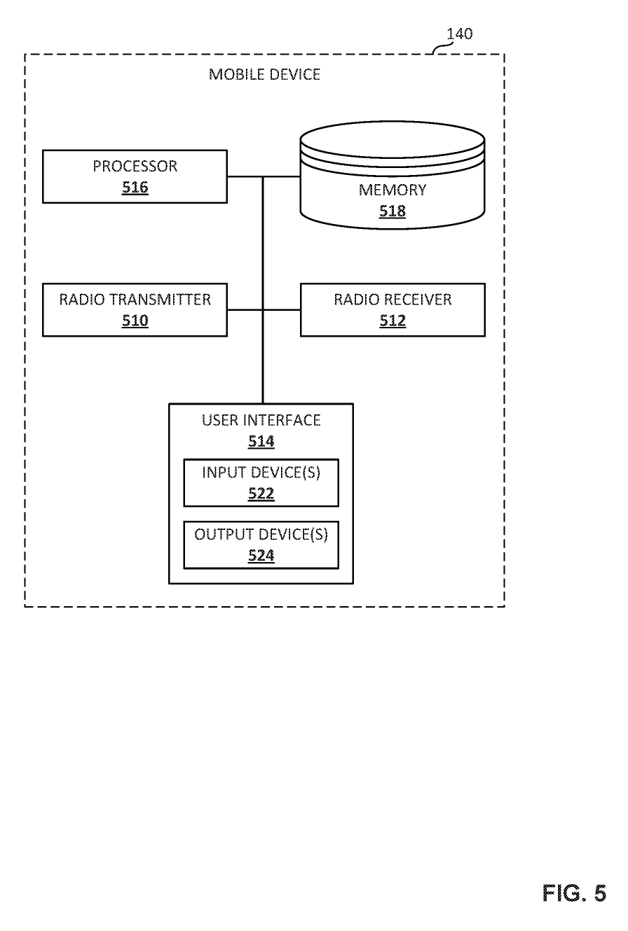

FIG. 5 is a block diagram of the example mobile device 140 of FIGS. 1 and 2 constructed in accordance with the teachings of this disclosure. In the illustrated example of FIG. 5, the mobile device 140 includes an example radio transmitter 510, an example radio receiver 512, an example user interface 514, an example processor 516, and an example memory 518. However, other example implementations of the mobile device 140 may include fewer or additional structures in accordance with the teachings of this disclosure.

The example radio transmitter 510 of FIG. 5 transmits data and/or one or more signal(s) to the remote server 136 of FIGS. 1, 2 and 4. In some examples, the data and/or signal(s) transmitted by the radio transmitter 510 to the remote server 136 are communicated via a network such as the example cellular network 138 of FIGS. 1 and 2. In some examples, the radio transmitter 510 may transmit data and/or signal(s) corresponding to one or more request(s) for traffic information. In some examples, the request includes the current position and/or location of the mobile device 140. Data corresponding to the signal(s) to be transmitted by the radio transmitter 510 may be of any type, form and/or format, and may be stored in a computer-readable storage medium such as the example memory 518 described below.

The example radio receiver 512 of FIG. 5 collects, acquires and/or receives data and/or one or more signal(s) from the remote server 136 of FIGS. 1, 2 and 4. In some examples, the data and/or signal(s) received by the radio receiver 512 from the remote server 136 are communicated via a network such as the example cellular network 138 of FIGS. 1 and 2. In some examples, the radio receiver 512 may receive data and/or signal(s) corresponding to lane and vehicle type-specific traffic information. Data identified and/or derived from the signal(s) collected and/or received by the radio receiver 512 may be of any type, form and/or format, and may be stored in a computer-readable storage medium such as the example memory 518 described below.

The example user interface 514 of FIG. 5 facilitates interactions and/or communications between an end user and the mobile device 140. The user interface 514 includes one or more input device(s) 522 via which the user may input information and/or data to the mobile device 140. For example, the user interface 514 may be a button, a microphone, and/or a touchscreen that enable(s) the user to convey data and/or commands to the mobile device 140. As further described below in connection with FIG. 6, the input device(s) 522 of the user interface 514 may enable an end user to request lane and vehicle type-specific traffic information to be presented via the user interface 514, and/or to filter lane and vehicle type-specific traffic information being presented and/or to be presented via the user interface 514.

The user interface 514 of FIG. 5 also includes one or more output device(s) 524 via which the processor 516 of the mobile device 140 presents information and/or data in visual and/or audible form to the user. For example, the user interface 514 may include a light emitting diode, a touchscreen, and/or a liquid crystal display for presenting visual information, and/or a speaker for presenting audible information. As further described below in connection with FIG. 6, lane and vehicle type-specific traffic information may be presented via the output device(s) 524 of the user interface 514. Data and/or information that is presented and/or received via the user interface 514 may be of any type, form and/or format, and may be stored in a computer-readable storage medium such as the example memory 518 described below.

The example processor 516 of FIG. 5 may be implemented by a semiconductor device such as a microprocessor, controller or microcontroller. The processor 516 manages and/or controls the operation of the mobile device 140 based on data, information and/or one or more signal(s) obtained and/or accessed by the processor 516 from one or more of the radio receiver 512, the user interface 514 and/or the memory 518, and/or based on data, information and/or one or more signal(s) provided by the processor 516 to one or more of the radio transmitter 510 and/or the user interface 514.

In some examples, the processor 516 of FIG. 5 instructs the radio transmitter 510 of FIG. 5 to transmit a request for traffic information (e.g., a request for lane and vehicle type-specific traffic information). For example, the processor 516 may provide one or more command(s) and/or instruction(s) to the radio transmitter 510 instructing the radio transmitter 510 to transmit one or more request(s) for traffic information to the remote server 136 of FIGS. 1, 2 and 4. In some examples, such command(s) and/or instruction(s) may be predetermined and/or otherwise defined by an application and/or program executing on the mobile device 140. In other examples, such command(s) and/or instruction(s) may be associated with one or more user input(s) received via the input device(s) 522 of the user interface 514 of FIG. 5. In response to such command(s) and/or instruction(s), the radio transmitter 510 may transmit one or more request(s) for traffic information via the cellular network 138.

In some examples, the processor 516 of FIG. 5 instructs the user interface 514 of FIG. 5 to present lane and vehicle type-specific traffic information. For example, the processor 516 may provide one or more command(s) and/or instruction(s) to the user interface 514 instructing the user interface 514 to present the lane and vehicle type-specific traffic information received from the remote server 136 of FIGS. 1, 2 and 4. In some examples, such command(s) and/or instruction(s) may be predetermined and/or otherwise defined by an application and/or program executing on the mobile device 140. In other examples, such command(s) and/or instruction(s) may be associated with one or more user input(s) received via the input device(s) 522 of the user interface 514 of FIG. 5. In response to such command(s) and/or instruction(s), the user interface 514 may present the lane and vehicle type-specific traffic information. An example of lane and vehicle type-specific traffic information presented via the user interface 514 of FIG. 5 is further described below in connection with FIG. 6.

In some examples, the processor 516 of FIG. 5 determines whether to filter the lane and vehicle type-specific traffic information being presented and/or to be presented via the user interface 514 of FIG. 5. For example, the processor 516 may receive one or more command(s) and/or instruction(s) indicating that the lane and vehicle type-specific information is to be filtered based on one or more vehicle type(s) and/or lane type(s). As one example, the command(s) and/or instruction(s) may indicate that the lane and vehicle type-specific traffic information is to be filtered to remove and/or mask one or more portion(s) of the lane and vehicle type-specific information associated with vehicle types other than cars. As another example, the command(s) and/or instruction(s) may indicate that the lane and vehicle type-specific traffic information is to be filtered to remove and/or mask one or more portion(s) of the lane and vehicle type-specific information associated with lane types other than carpool lanes. In some examples, the command(s) and/or instruction(s) received by the processor 516 may be predetermined and/or otherwise defined by an application and/or program executing on the mobile device 140. In other examples, such command(s) and/or instruction(s) may be associated with one or more user input(s) received via the input device(s) 522 of the user interface 514 of FIG. 5.

In some examples, the processor 516 of FIG. 5 filters, and/or instructs the user interface 514 of FIG. 5 to filter, the lane and vehicle type-specific traffic information being presented and/or to be presented via the user interface 514 of FIG. 5. For example, the processor 516 and/or the user interface 514 may filter the lane and vehicle type-specific traffic information by removing and/or masking one or more portion(s) of the lane and vehicle type-specific traffic information corresponding to one or more vehicle type(s) and/or lane type(s). As one example, the processor 516 and/or the user interface 514 may remove and/or mask one or more portion(s) of the lane and vehicle type-specific traffic information associated with vehicle types other than cars. As another example, the processor 516 and/or the user interface 514 may remove and/or mask one or more portion(s) of the lane and vehicle type-specific traffic information associated with lane types other than carpool lanes.

In some examples, the processor 516 of FIG. 5 determines whether lane and vehicle type-specific traffic information is to continue being presented via the example user interface 514 of FIG. 5. For example, the processor 516 may receive one or more command(s) and or instruction(s) indicating that lane and vehicle type-specific traffic information is not to continue being presented. In some examples, such command(s) and/or instruction(s) may be predetermined and/or otherwise defined by an application and/or program executing on the mobile device 140. In other examples, such command(s) and/or instruction(s) may be associated with one or more user input(s) received via the input device(s) 522 of the user interface 514 of FIG. 5. If the processor 516 determines that lane and vehicle type-specific traffic information is not to continue being presented, the processor 516 may provide one or more control signal(s) and/or instruction(s) to the user interface 514 of FIG. 5 indicating that the lane and vehicle type-specific traffic information is not to continue being presented. In response to such signal(s) and/or instruction(s), the user interface 514 may cease presenting the lane and vehicle type-specific traffic information.

The example memory 518 of FIG. 5 may be implemented by any type(s) and/or any number(s) of storage device(s) such as a storage drive, a flash memory, a read-only memory (ROM), a random-access memory (RAM), a cache and/or any other storage medium in which information is stored for any duration (e.g., for extended time periods, permanently, brief instances, for temporarily buffering, and/or for caching of the information). The information stored in the memory 518 may be stored in any file and/or data structure format, organization scheme, and/or arrangement. In some examples, the memory 518 stores lane and vehicle type-specific traffic information collected and/or received by the radio receiver 512, and/or lane and vehicle type-specific traffic information to be presented via the user interface 514. The memory 518 is accessible to the example radio transmitter 510, the example radio receiver 512, the example user interface 514, and the example processor 516 of FIG. 5, and/or, more generally, to the example mobile device 140 of FIGS. 1, 2 and 5.

While an example manner of implementing the example mobile device 140 is illustrated in FIG. 5, one or more of the elements, processes and/or devices illustrated in FIG. 5 may be combined, divided, re-arranged, omitted, eliminated and/or implemented in any other way. Further, the example radio transmitter 510, the example radio receiver 512, the example user interface 514, the example processor 516 and/or the example memory 518 of FIG. 5 may be implemented by hardware, software, firmware and/or any combination of hardware, software and/or firmware. Thus, for example, any of the example radio transmitter 510, the example radio receiver 512, the example user interface 514, the example processor 516 and/or the example memory 518 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example radio transmitter 510, the example radio receiver 512, the example user interface 514, the example processor 516 and/or the example memory 518 is/are hereby expressly defined to include a tangible computer readable storage device or storage disk such as a memory, a SD card, etc. storing the software and/or firmware. Further still, the example mobile device 140 of FIG. 5 may include one or more elements, processes and/or devices in addition to, or instead of, those illustrated in FIG. 5, and/or may include more than one of any or all of the illustrated elements, processes and devices.

FIG. 6 illustrates an example user interface 602 of an example electronic device 604 presenting an example map 606 including example lane and vehicle type-specific traffic information. In some examples, the user interface 602 of the electronic device 604 of FIG. 6 may be implemented as the example user interface 314 of the example onboard navigation system 134 of FIGS. 1-3. In other examples, the user interface 602 of the electronic device 604 of FIG. 6 may be implemented as the example user interface 514 of the example mobile device 140 of FIGS. 1, 2 and 5.

In the illustrated example of FIG. 6, the map 606 includes a graphical representation and/or indication of lane and vehicle type-specific traffic information, such as lane and vehicle type-specific traffic information generated by the example remote server 136 of FIGS. 1, 2 and 4. The map 606 of FIG. 6 includes a graphical representation and/or indication of an example roadway segment 608 (e.g., a length and/or area of the example roadway 112 of FIGS. 1 and 2) to which the lane and vehicle type-specific traffic information pertains. While the example map 606 of FIG. 6 includes graphical representations of two roadway segments shown at a particular level of detail and/or resolution, the map 606 may include graphical representations of any number of roadway segments, and each roadway segment may be presented at any level of detail and/or resolution. The map 606 may include any number of roadway segments presented at any level of detail and/or resolution.

The map 606 of FIG. 6 also includes an example map legend 610 having one or more description(s) and/or indication(s) associated with one or more graphic(s) and/or icon(s) representing one or more portion(s) of the lane and vehicle type-specific traffic information being presented. For example, the map legend 610 of FIG. 6 indicates that an example first portion of the graphically presented lane and vehicle type-specific traffic information is represented by an example first graphic 612 having a first line thickness, a first symbol and a first color. The first line thickness (e.g., a relatively thin line) is indicative of traffic for cars, the first symbol (e.g., an arrow having a tail with a diamond affixed thereto) is indicative of a carpool lane, and the first color (e.g., a green color) is indicative of low density (e.g., clear and/or fast moving) traffic. The first graphic 612 of the presented lane and vehicle type-specific traffic information accordingly indicates, based on the map legend 610 of FIG. 6, that traffic for cars traveling in a carpool lane (e.g., a first portion of the lane and vehicle type-specific traffic information) of the displayed roadway portion 608 is clear and/or fast moving.

As another example, the map legend 610 of FIG. 6 further indicates that an example second portion of the graphically presented lane and vehicle type-specific traffic information is represented by an example second graphic 614 having a second line thickness (e.g., a relatively thin line matching the first line thickness), a second symbol (e.g., an arrow) and a second color (e.g., a green color matching the first color). The second line thickness is indicative of traffic for cars, the second symbol is indicative of a regular lane, and the second color is indicative of low density (e.g., clear and/or fast moving) traffic. The second graphic 614 of the presented lane and vehicle type-specific traffic information accordingly indicates, based on the map legend 610 of FIG. 6, that traffic for cars traveling in a regular lane (e.g., a second portion of the lane and vehicle type-specific traffic information) of the displayed roadway portion 608 is clear and/or fast moving.

As another example, the map legend 610 of FIG. 6 further indicates that an example third portion of the lane and vehicle type-specific traffic information is represented by an example third graphic 616 having a third line thickness (e.g., a relatively thick line), a third symbol (e.g., an arrow matching the second symbol) and a third color (e.g., a red color). The third line thickness is indicative of traffic for trucks, the third symbol is indicative of a regular lane, and the third color is indicative of high density (e.g., heavy and/or slow moving) traffic. The third graphic 616 of the presented lane and vehicle type-specific traffic information accordingly indicates, based on the map legend 610 of FIG. 6, that traffic for trucks traveling in a regular lane (e.g., a third portion of the lane and vehicle type-specific traffic information) of the displayed roadway portion 608 is heavy and/or fast moving.

In the illustrated example of FIG. 6, the above-described combinations of graphical properties associated with each of the first, second and third graphic(s) 612, 614, 616 of the lane and vehicle type-specific traffic information presented on the map 606 and described by the map legend 610 enable an end user to distinguish each of the corresponding first, second and third portion(s) of lane and vehicle type-specific traffic information from the other (e.g., (e.g., a first portion corresponding to traffic for cars traveling in a carpool lane, a second portion corresponding to traffic for cars traveling in a regular lane, and a third portion corresponding to traffic for trucks traveling in a regular lane).

In some examples, the user interface 602 may enable an end user (e.g., via one or more input device(s) such as the input device(s) 322 of the user interface 314 described above) to filter the presented lane and vehicle type-specific traffic information to include only the portion(s) of the lane and vehicle type-specific traffic information that are of interest to the end user. For example, the end user may instruct the user interface 602 to filter the presented lane and vehicle type-specific traffic information to include only the above-described first portion of the lane and vehicle type-specific traffic information that is specific to traffic information for cars traveling in carpool lanes. In some such examples, the first graphic 612 of the map legend 610 of FIG. 6 may be selectable such that the filtering occurs in response to the end user pressing and/or otherwise selecting the first graphic 612 via the user interface 602 (e.g., by pressing an area of a touchscreen of the user interface 602 at which the first graphic 612 appears).

FIG. 7 illustrates the example user interface 602 of the example electronic device 604 of FIG. 6 presenting an example route 702 to be followed by a vehicle. The presented route 702 of FIG. 7 is based on an example vehicle type 704 of the vehicle, an example lane type 706 of travel for the vehicle, and the example lane and vehicle type-specific traffic information presented on the example map 606 of FIG. 6. In the illustrated example of FIG. 7, the route 702 is to be followed by a vehicle that is a car that will be traveling in a carpool lane. Thus, the route 702 of FIG. 7 is based on the vehicle type 704 corresponding to a car, the lane type 706 corresponding to a carpool lane, and the first portion of the lane and vehicle type-specific traffic information of FIG. 6 described above. In the illustrated example of FIG. 7, the legend 610 of the map 606 of the user interface 602 includes a textual description of the vehicle type 704 associated with the route 702, a textual description of the lane type 706 associated with the route 702, and a textual description of example directions 708 associated with the route 702.

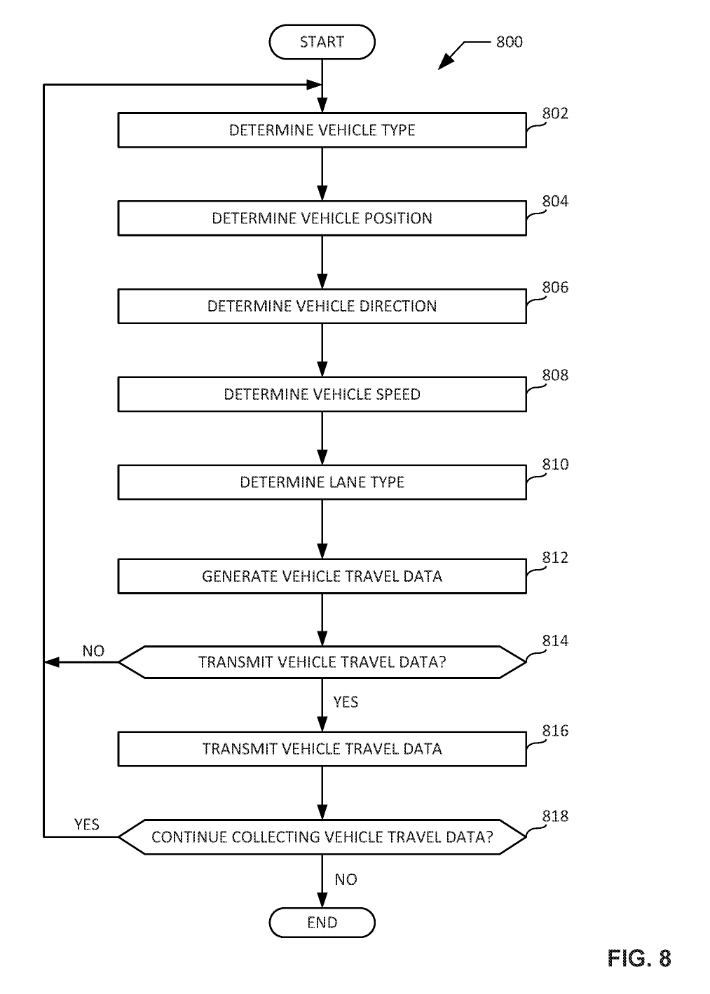

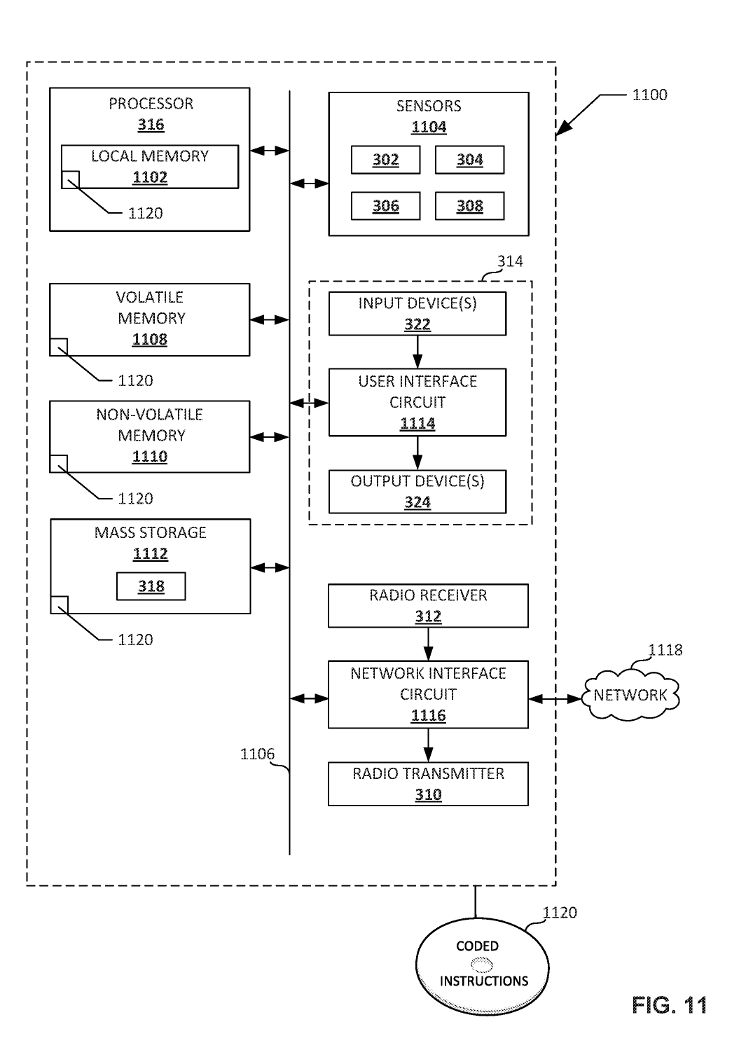

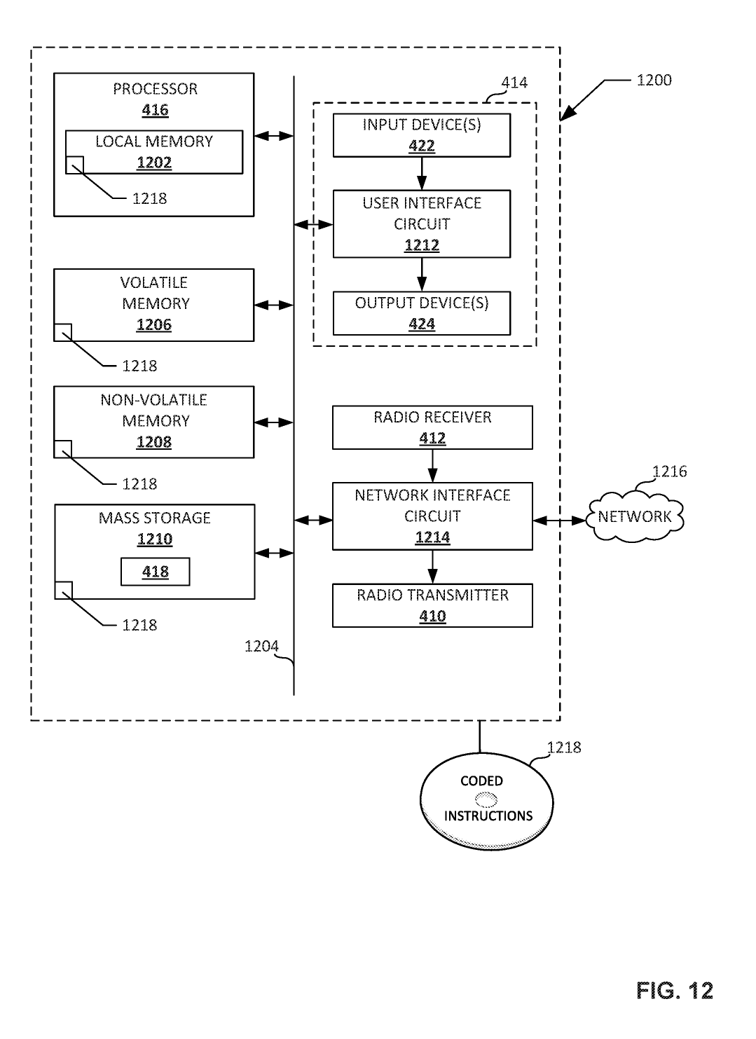

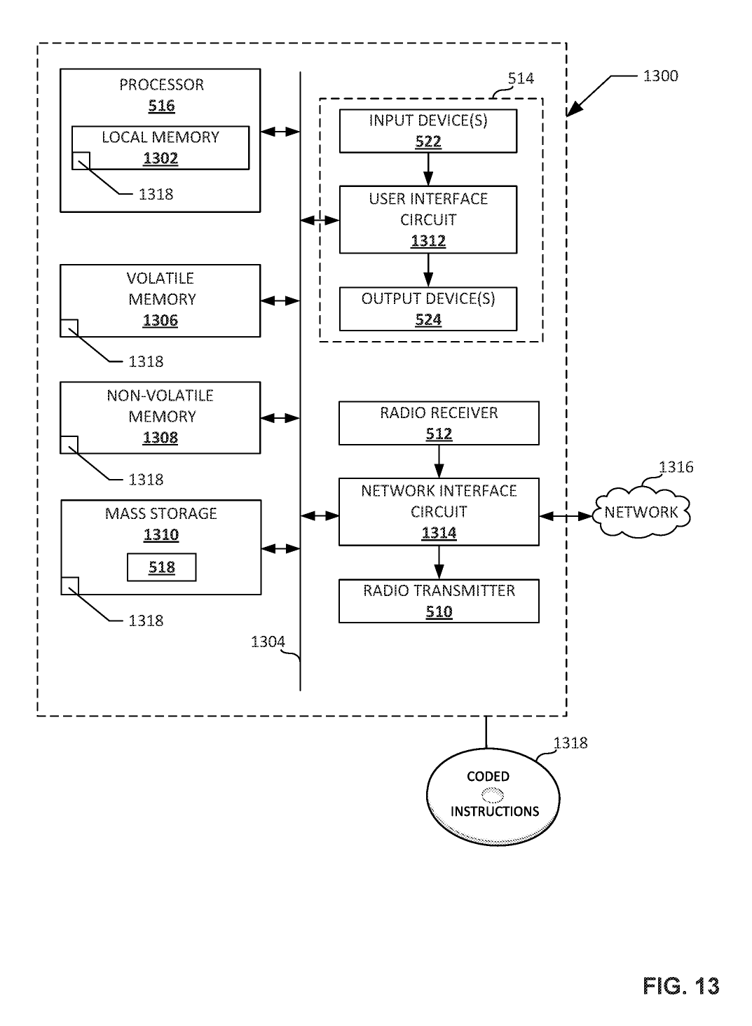

Flowcharts representative of example methods for collecting and transmitting example vehicle travel data of an example vehicle, for generating and transmitting example lane and vehicle type-specific traffic information, and for presenting example lane and vehicle type-specific traffic information are shown in FIGS. 8-10. In these examples, the methods may be implemented using machine-readable instructions that comprise one or more program(s) for execution by a processor such as the example processor 316 of FIG. 3 shown in the example processor platform 1100 discussed below in connection with FIG. 11, the example processor 416 of FIG. 4 shown in the example processor platform 1200 discussed below in connection with FIG. 12, and/or the example processor 516 of FIG. 5 shown in the example processor platform 1300 discussed below in connection with FIG. 13. The one or more program(s) may be embodied in software stored on a tangible computer readable storage medium such as a CD-ROM, a floppy disk, a hard drive, a digital versatile disk (DVD), a Blu-ray disk, or a memory associated with the processor 316, the processor 416, and/or the processor 516, but the entire program(s) and/or parts thereof could alternatively be executed by a device other than the processor 316, the processor 416 or the processor 516, and/or embodied in firmware or dedicated hardware. Further, although the example program(s) is/are described with reference to the flowcharts illustrated in FIGS. 8-10, many other methods for collecting and transmitting example vehicle travel data of an example vehicle, for generating and transmitting example lane and vehicle type-specific traffic information, and for presenting example lane and vehicle type-specific traffic information may alternatively be used. For example, the order of execution of the blocks may be changed, and/or some of the blocks described may be changed, eliminated, or combined.

As mentioned above, the example methods of FIGS. 8-10 may be implemented using coded instructions (e.g., computer and/or machine-readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term “tangible computer readable storage medium” is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example methods of FIGS. 8-10 may be implemented using coded instructions (e.g., computer and/or machine-readable instructions) stored on a non-transitory computer and/or machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term “non-transitory computer readable medium” is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

FIG. 8 is a flowchart representative of an example method 800 that may be executed at the example onboard navigation system 134 of FIGS. 1-3 to collect and transmit example vehicle travel data of an example vehicle. The example method 800 begins when the example processor 316 of FIG. 3 determines a vehicle type of the vehicle (block 802). For example, the processor 316 may access, obtain, and/or otherwise identify the vehicle type identification data 326 of FIG. 3 from the memory 318 of FIG. 3. Following block 802, control of the example method 800 of FIG. 8 proceeds to block 804.

At block 804, the example processor 316 of FIG. 3 determines a position of the vehicle (block 804). For example, the processor 316 may access, obtain and/or otherwise identify the vehicle position data identified and/or derived from the signal(s) collected and/or received by the GNSS/GPS receiver 302 of FIG. 3. The vehicle position data accessed, obtained and/or otherwise identified by the processor 316 may include timing information (e.g., time stamps) corresponding to times at which the vehicle position data was collected and/or received by the GNSS/GPS receiver 302. Following block 804, control of the example method 800 of FIG. 8 proceeds to block 806.

At block 806, the example processor 316 of FIG. 3 determines a direction of the vehicle (block 806). For example, the processor 316 may access, obtain and/or otherwise identify the vehicle direction data sensed, measured and/or detected by the compass 304 of FIG. 3. The vehicle direction data accessed, obtained and/or otherwise identified by the processor 316 may include timing information (e.g., time stamps) corresponding to times at which the vehicle direction data was sensed, measured and/or detected by the compass 304. Following block 806, control of the example method 800 of FIG. 8 proceeds to block 808.

At block 808, the example processor 316 of FIG. 3 determines a speed of the vehicle (block 808). For example, the processor 316 may access, obtain and/or otherwise identify the vehicle speed data sensed, measured and/or detected by the speed sensor 306 of FIG. 3. The vehicle speed data accessed, obtained and/or otherwise identified by the processor 316 may include timing information (e.g., time stamps) corresponding to times at which the vehicle speed data was sensed, measured and/or detected by the speed sensor 306. Following block 808, control of the example method 800 of FIG. 8 proceeds to block 810.

At block 810, the example processor 316 of FIG. 3 determines a lane type of the vehicle (block 810). For example, the processor 316 may access, obtain, and/or otherwise identify lane type identification data sensed, identified and/or detected by the lane type detector 308 of FIG. 3. In some examples, the lane type identification data accessed, obtained, and/or otherwise identified by the processor 316 may include date sensed, identified and/or detected by the lane type detector 308 in conjunction with the lane type library 320 of FIG. 3. The lane type identification data accessed, obtained and/or otherwise identified by the processor 316 may include timing information (e.g., time stamps) corresponding to times at which the lane type identification data was sensed, identified and/or detected by the lane type detector 308. Following block 810, control of the example method 800 of FIG. 8 proceeds to block 812.

At block 812, the example processor 316 of FIG. 3 generates vehicle travel data based on the vehicle position data, the vehicle direction data, the vehicle speed data, the vehicle type identification data, and the lane type identification data (block 812). In some examples, the vehicle travel data is synchronized and/or otherwise organized based on the timing information associated with each of the vehicle position data, the vehicle direction data, the vehicle speed data, and the lane type identification data. For example, first data and/or first data point of the vehicle travel data may include a position of the vehicle at a first time, a direction of the vehicle at the first time, a speed of the vehicle at the first time, and a lane type corresponding to a lane in which the vehicle was traveling at the first time. Second data and/or second data point of the vehicle travel data may include a position of the vehicle at a second time subsequent to the first time, a direction of the vehicle at the second time, a speed of the vehicle at the second time, and a lane type corresponding to a lane in which the vehicle was traveling at the second time. One or more of the first and/or second data and/or the first and/or second data point(s) may also include the vehicle type identification data corresponding to the vehicle. Following block 812, control of the example method 800 of FIG. 8 proceeds to block 814.

At block 814, the example processor 316 of FIG. 3 determines whether to transmit vehicle travel data for the vehicle (block 814). For example, the processor 316 may receive one or more command(s) and or instruction(s) indicating that vehicle travel data for the vehicle is to be transmitted to the remote server 136 of FIGS. 1, 2 and 4. In some examples, such command(s) and/or instruction(s) may be predetermined and/or otherwise defined by an application and/or program executing on the onboard navigation system 134. In other examples, such command(s) and/or instruction(s) may be associated with one or more user input(s) received via the input device(s) 322 of the user interface 314 of FIG. 3. If the processor 316 determines at block 814 not to transmit vehicle travel data for the vehicle, control of the example method 800 of FIG. 8 returns to block 802. If the processor 316 instead determines at block 814 to transmit vehicle travel data for the vehicle, control of the example method 800 of FIG. 8 proceeds to block 816.

At block 816, the example radio transmitter 310 of FIG. 3 transmits vehicle travel data for the vehicle (block 816). For example, the radio transmitter 310 may transmit the vehicle travel data generated by the processor 316 of FIG. 3 to the remote server 136 of FIGS. 1, 2 and 4 via the cellular network 138 of FIGS. 1 and 2. Following block 816, control of the example method 800 of FIG. 8 proceeds to block 818.

At block 818, the example processor 316 of FIG. 3 determines whether vehicle travel data for the vehicle is to continue being collected (block 818). For example, the processor 316 may receive one or more command(s) and or instruction(s) indicating that vehicle travel data for the vehicle is not to continue being collected. In some examples, such command(s) and/or instruction(s) may be predetermined and/or otherwise defined by an application and/or program executing on the onboard navigation system 134. In other examples, such command(s) and/or instruction(s) may be associated with one or more user input(s) received via the input device(s) 322 of the user interface 314 of FIG. 3. If the processor 316 determines at block 818 that vehicle travel data for the vehicle is to continue being collected, control of the example method 800 of FIG. 8 returns to block 802. In some examples, the processor 316 may determine that vehicle travel data for the vehicle is to continue being collected, generated and/or transmitted on a periodic basis (e.g., according to a predetermined frequency and/or in response to the occurrence of a predetermined event). If the processor 316 instead determines at block 818 that vehicle travel data for the vehicle is not to continue being collected, control of the example method 800 of FIG. 8 ends.

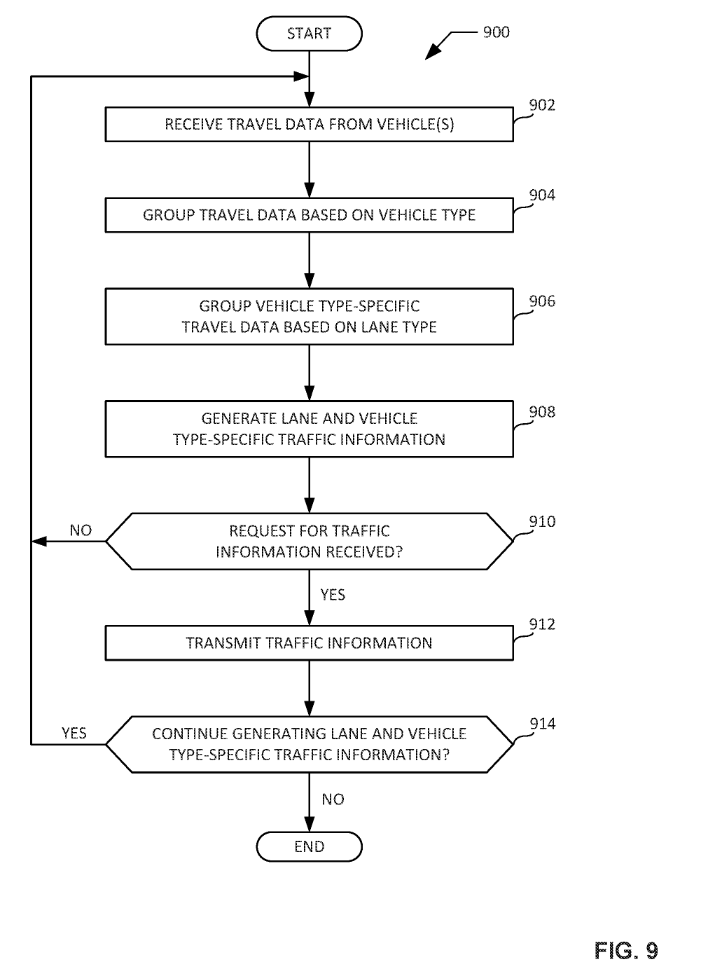

FIG. 9 is a flowchart representative of an example method 900 that may be executed at the example remote server 136 of FIGS. 1, 2 and 4 to generate and transmit example lane and vehicle type-specific traffic information. The example method 900 begins when the remote server 136 receives vehicle travel data from one or more vehicle(s) (block 902). For example, the radio receiver 412 of FIG. 4 and/or the remote server 136 of FIGS. 1, 2 and 4 may receive vehicle travel data generated by and/or transmitted by one or more of the onboard navigation system(s) 134 of FIGS. 1-3 via the cellular network 138 of FIGS. 1 and 2. Following block 902, control of the example method 900 of FIG. 9 proceeds to block 904.

At block 904, the example processor 416 of FIG. 4 groups the received vehicle travel data based on a vehicle type associated with the vehicle travel data of each vehicle (block 904). For example, the processor 416 may group and/or otherwise associate various packets of vehicle travel data received at the remote server 136 based on the vehicle type identification data included in each packet of vehicle travel data. As one example, the processor 416 may group together packets of vehicle travel data commonly having vehicle type identification data indicative of a vehicle type corresponding to a car. As another example, the processor 416 may group together packets of vehicle travel data commonly having vehicle type identification data indicative of a vehicle type corresponding to a truck. Following block 904, control of the example method 900 of FIG. 9 proceeds to block 906.

At block 906, the example processor 416 of FIG. 4 groups the vehicle type-specific vehicle travel data based on a lane type associated with the vehicle data of each vehicle (block 906). For example, the processor 416 may group and/or otherwise associate various packets of vehicle travel data received at the remote server 136 based on the lane type identification data included in each packet of vehicle travel data. As one example, the processor 416 may group together packets of vehicle travel data commonly having lane type identification data indicative of a lane type corresponding to a carpool lane. As another example, the processor 416 may group together packets of vehicle travel data commonly having lane type identification data indicative of a lane type corresponding to a regular lane. Following block 906, control of the example method 900 of FIG. 9 proceeds to block 908.

At block 908, the example processor 416 of FIG. 4 generates lane and vehicle type-specific traffic information (block 908). For example, the processor 416 may generate lane and vehicle type-specific traffic information by determining, for one or more segment(s) of a roadway (e.g., a specific length and/or area of a roadway), an average vehicle speed of one or more vehicle(s) represented by each grouping and/or association of vehicle travel data provided by the processor 416. The processor 416 may assign and/or append codes, textual descriptors and/or graphics to each grouping and/or association such that the traffic information for each grouping and/or association within the lane and vehicle type-specific traffic information is unique and/or distinguishable when presented on a user interface. For example, the processor 416 may configure the lane and vehicle type-specific traffic information such that different portions of the traffic information corresponding to the different groupings and/or associations of vehicle travel data provided by the processor 416 include and/or are associated with graphics that, when presented on a user interface of an electronic device (e.g., the user interface 314 of the onboard navigation system 134 of FIGS. 1-3 or the user interface 514 of the mobile device 140 of FIGS. 1, 2 and 5), enable an end user to distinguish a first portion of the lane and vehicle type-specific traffic information (e.g., cars traveling in a carpool lane) from a second portion of the lane and vehicle type-specific traffic information (e.g., cars traveling in a regular lane) and/or from a third portion of the lane and vehicle type-specific traffic information (e.g., trucks traveling in a regular lane).

In some examples, the processor 416 of FIG. 4, in conjunction with generating the lane and vehicle type-specific traffic information at block 908, may configure the lane and vehicle type-specific traffic information to be graphically displayed on, as part of, and/or in conjunction with a map representing one or more segment(s) of a roadway (e.g., a specific length and/or area of a roadway) to which the lane and vehicle type-specific traffic information pertains. The processor 416 may further configure the lane and vehicle type-specific traffic information and/or the map to include a map legend having one or more description(s) and/or indication(s) associated with one or more graphic(s) and/or icon(s) representing one or more portion(s) of the lane and vehicle type-specific traffic information when presented. For example, the lane and vehicle type-specific traffic information generated by the processor 416 may include coding (e.g., one or more graphic(s)) that provides an indication of particular portions represented by the lane and vehicle type-specific traffic information. As one example, the processor 416 may configure a first portion of the lane and vehicle type-specific traffic information to be graphically represented by a first graphic having a first line thickness, a first symbol and a first color. The first line thickness may be indicative of traffic for cars, the first symbol may be indicative of a carpool lane, and the first color may be indicative of low density (e.g., clear and/or fast moving) traffic. As another example, the processor 416 may configure a second portion of the lane and vehicle type-specific traffic information to be graphically represented by a second graphic having a second line thickness, a second symbol and a second color. The second line thickness may be indicative of traffic for cars, the second symbol may be indicative of a regular lane, and the second color may be indicative of low density (e.g., clear and/or fast moving) traffic. As another example, the processor 416 may configure a third portion of the lane and vehicle type-specific traffic information to be graphically represented by a third graphic having a third line thickness, a third symbol and a third color. The third line thickness may be indicative of traffic for trucks, the third symbol may be indicative of a regular lane, and the third color may be indicative of high density (e.g., heavy and/or slow moving) traffic. In such examples, the map legend configured by the processor 416 in connection with generating the lane and vehicle type-specific traffic information may include one or more description(s) and/or indication(s) corresponding to one or more of the first, second and/or third graphic(s). Following block 908, control of the example method 900 of FIG. 9 proceeds to block 910.

At block 910, the example processor 416 of FIG. 4 determines whether a request for traffic information has been received at the remote server 136 (block 910). For example, the processor 416 may receive one or more command(s) and or instruction(s) indicating that the radio receiver 412 of FIG. 4 and/or the remote server 136 of FIGS. 1, 2 and 4 has received a request for traffic information via the cellular network 138 of FIGS. 1 and 2. In some examples, such command(s) and/or instruction(s) may be predetermined and/or otherwise defined by an application and/or program executing on the remote server 136. In some examples, the request may include the current position and/or location of an electronic device transmitting the request (e.g., the onboard navigation system 134 of FIGS. 1-3 and/or the mobile device 140 of FIGS. 1, 2 and 5). If the processor 416 determines at block 910 that a request for traffic information has not been received, control of the example method 900 of FIG. 9 returns to block 902. If the processor 416 instead determines at block 910 that a request for traffic information has been received, control of the example method 900 of FIG. 9 proceeds to block 912.

At block 912, the remote server 136 transmits lane and vehicle type-specific traffic information (block 912). For example, the radio transmitter 410 of FIG. 4 and/or the remote server 136 of FIGS. 1, 2 and 4 may transmit the lane and vehicle type-specific traffic information generated by the processor 416 of FIG. 4 to the onboard navigation system 134 of FIGS. 1-3 and/or to the mobile device 140 of FIGS. 1, 2 and 5 via the cellular network 138 of FIGS. 1 and 2. In some examples, the transmitted lane and vehicle type-specific traffic information may be tailored to the current position and/or location of the onboard navigation system 134 and/or the mobile device 140. Following block 912, control of the example method 900 of FIG. 9 proceeds to block 914.

At block 914, the example processor 416 of FIG. 4 determines whether to continue generating lane and vehicle type-specific traffic information (block 914). For example, the processor 416 may receive one or more command(s) and or instruction(s) indicating that lane and vehicle type-specific traffic information is not to continue being generated. In some examples, such command(s) and/or instruction(s) may be predetermined and/or otherwise defined by an application and/or program executing on the remote server 136. In other examples, such command(s) and/or instruction(s) may be associated with one or more user input(s) received via the input device(s) 422 of the user interface 414 of FIG. 4. If the processor 416 determines at block 914 that lane and vehicle type-specific traffic information is to continue being generated, control of the example method 900 of FIG. 9 returns to block 902. In some examples, the processor 416 may determine that lane and vehicle type-specific traffic information is to continue being generated and/or transmitted on a periodic basis (e.g., according to a predetermined frequency and/or in response to the occurrence of a predetermined event). If the processor 416 instead determines at block 914 that lane and vehicle type-specific traffic information is not to continue being generated, control of the example method 900 of FIG. 9 ends.

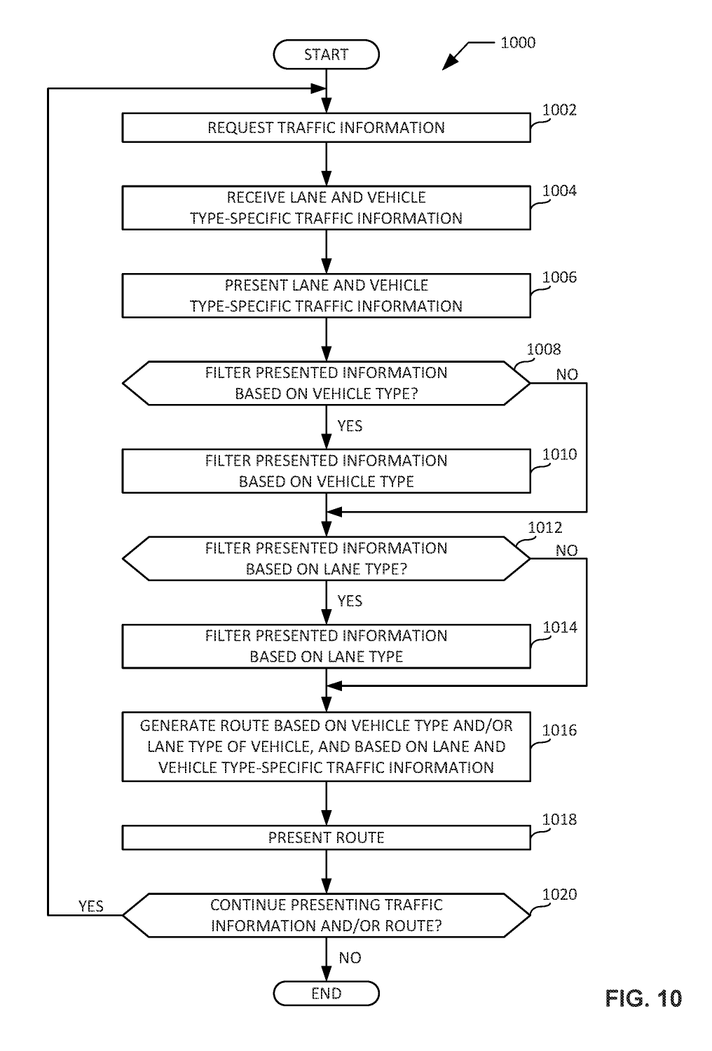

FIG. 10 is a flowchart representative of an example method 1000 that may be executed at the example onboard navigation system 134 of FIGS. 1-3 or at the example mobile device 140 of FIGS. 1, 2 and 5 to present example lane and vehicle type-specific traffic information. Although the description of the example method 1000 of FIG. 10 provided herein is made with reference to components of the example onboard navigation system 134 of FIGS. 1-3, the described process(es), step(s) and/or function(s) may similarly be performed by corresponding components (e.g., like-numbered and/or like-named components) of the example mobile device 140 of FIGS. 1, 2 and 5.

The example method 1000 of FIG. 10 begins when the example radio transmitter 310 of FIG. 3 transmits a request for traffic information (block 1002). For example, the processor 316 of FIG. 3 may provide one or more command(s) and/or instruction(s) to the radio transmitter 310 instructing the radio transmitter 310 to transmit one or more request(s) for traffic information to the remote server 136 of FIGS. 1, 2 and 4 via the example cellular network 138 of FIGS. 1 and 2. In some examples, such command(s) and/or instruction(s) may be predetermined and/or otherwise defined by an application and/or program executing on the onboard navigation system 134. In other examples, such command(s) and/or instruction(s) may be associated with one or more user input(s) received via the input device(s) 322 of the user interface 314 of FIG. 3. In response to such command(s) and/or instruction(s), the radio transmitter 310 may transmit one or more request(s) for traffic information via the cellular network 138 of FIGS. 1 and 2. In some examples, the request may include the current position and/or location of the onboard navigation system 134. Following block 1002, control of the example method 1000 of FIG. 10 proceeds to block 1004.

At block 1004, the example radio receiver 312 of FIG. 3 receives lane and vehicle type-specific traffic information (block 1004). For example, the radio receiver 312 may receive lane and vehicle type-specific traffic information generated by and/or transmitted by the remote server 136 of FIGS. 1, 2 and 4 via the cellular network 138 of FIGS. 1 and 2. In some examples, the radio receiver 312 receives the lane and vehicle type-specific traffic information in response to a request for traffic information transmitted to the remote server 136 via the radio transmitter 310 of FIG. 3. In some examples, the received lane and vehicle type-specific traffic information may be tailored to the current position and/or location of the onboard navigation system 134. Following block 1004, control of the example method 1000 of FIG. 10 proceeds to block 1006.

At block 1006, the example user interface 314 of FIG. 3 presents the lane and vehicle type-specific traffic information (block 1006). For example, the processor 316 of FIG. 3 may provide one or more command(s) and/or instruction(s) to the user interface 314 instructing the user interface 314 to present the lane and vehicle type-specific traffic information received from the remote server 136 of FIGS. 1, 2 and 4. In some examples, such command(s) and/or instruction(s) may be predetermined and/or otherwise defined by an application and/or program executing on the onboard navigation system 134. In other examples, such command(s) and/or instruction(s) may be associated with one or more user input(s) received via the input device(s) 322 of the user interface 314 of FIG. 3. In response to such command(s) and/or instruction(s), the user interface 314 may present the lane and vehicle type-specific traffic information. Following block 1006, control of the example method 1000 of FIG. 10 proceeds to block 1008.

At block 1008, the example processor 316 of FIG. 3 determines whether to filter the presented lane and vehicle type-specific traffic information based on vehicle type (block 1008). For example, the processor 316 may receive one or more command(s) and/or instruction(s) indicating that the lane and vehicle type-specific information is to be filtered based on one or more vehicle type(s). As one example, the command(s) and/or instruction(s) may indicate that the lane and vehicle type-specific traffic information is to be filtered to remove and/or mask one or more portion(s) of the lane and vehicle type-specific information associated with vehicle types other than cars. In some examples, the command(s) and/or instruction(s) received by the processor 316 may be predetermined and/or otherwise defined by an application and/or program executing on the onboard navigation system 134. In other examples, such command(s) and/or instruction(s) may be associated with one or more user input(s) received via the input device(s) 322 of the user interface 314 of FIG. 3. If the processor 316 determines at block 1008 to filter the presented lane and vehicle type-specific traffic information based on vehicle type, control of the example method 1000 of FIG. 10 proceeds to block 1010. If the processor 316 instead determines at block 1008 not to filter the presented lane and vehicle type-specific traffic information based on vehicle type, control of the example method 1000 of FIG. 10 proceeds to block 1012.

At block 1010, the example processor 316 of FIG. 3 filters, and/or instructs the user interface 314 of FIG. 3 to filter, the presented lane and vehicle type-specific traffic information based on vehicle type (block 1010). For example, the processor 316 and/or the user interface 314 may filter the lane and vehicle type-specific traffic information by removing and/or masking one or more portion(s) of the lane and vehicle type-specific traffic information corresponding to one or more vehicle type(s). As one example, the processor 316 and/or the user interface 314 may remove and/or mask one or more portion(s) of the lane and vehicle type-specific traffic information associated with vehicle types other than cars. Following block 1010, control of the example method 1000 of FIG. 10 proceeds to block 1012.

At block 1012, the example processor 316 of FIG. 3 determines whether to filter the presented lane and vehicle type-specific traffic information based on lane type (block 1012). For example, the processor 316 may receive one or more command(s) and/or instruction(s) indicating that the lane and vehicle type-specific information is to be filtered based on one or more lane type(s). As one example, the command(s) and/or instruction(s) may indicate that the lane and vehicle type-specific traffic information is to be filtered to remove and/or mask one or more portion(s) of the lane and vehicle type-specific information associated with lane types other than carpool lanes. In some examples, the command(s) and/or instruction(s) received by the processor 316 may be predetermined and/or otherwise defined by an application and/or program executing on the onboard navigation system 134. In other examples, such command(s) and/or instruction(s) may be associated with one or more user input(s) received via the input device(s) 322 of the user interface 314 of FIG. 3. If the processor 316 determines at block 1012 to filter the presented lane and vehicle type-specific traffic information based on lane type, control of the example method 1000 of FIG. 10 proceeds to block 1014. If the processor 316 instead determines at block 1012 not to filter the presented lane and vehicle type-specific traffic information based on lane type, control of the example method 1000 of FIG. 10 proceeds to block 1016.

At block 1014, the example processor 316 of FIG. 3 filters, and/or instructs the user interface 314 of FIG. 3 to filter, the presented lane and vehicle type-specific traffic information based on lane type (block 1014). For example, the processor 316 and/or the user interface 314 may filter the lane and vehicle type-specific traffic information by removing and/or masking one or more portion(s) of the lane and vehicle type-specific traffic information corresponding to one or more lane type(s). As one example, the processor 316 and/or the user interface 314 may remove and/or mask one or more portion(s) of the lane and vehicle type-specific traffic information associated with lane types other than carpool lanes. Following block 1014, control of the example method 1000 of FIG. 10 proceeds to block 1016.

At block 1016, the example processor 316 of FIG. 3 generates a route to be followed by a vehicle based on a vehicle type of the vehicle and/or a lane type for travel of the vehicle, and further based on the lane and vehicle type-specific traffic information (block 1016). For example, the processor 316 may generate a first route for a vehicle that is a car that will be traveling in a carpool lane. The first route may be based on a first portion of the lane and vehicle type-specific traffic information corresponding to the identified vehicle type (e.g., a car) and/or the identified lane type (e.g., a carpool lane). As another example, the processor 316 may generate a second route for a vehicle that is a car that will be traveling in a regular lane. The second route may be based on a second portion of the lane and vehicle type-specific traffic information corresponding to the identified vehicle type (e.g., a car) and/or the identified lane type (e.g., a regular lane). As another example, the processor 316 may generate a third route for a vehicle that is a truck that will be traveling in a regular lane. The third route may be based on a third portion of the lane and vehicle type-specific traffic information corresponding to the identified vehicle type (e.g., a truck) and/or the identified lane type (e.g., a regular lane). Thus, in examples where a car and a truck may be traveling from a common origin to a common destination, the processor 316 may generate different routes for the car and the truck (e.g., a first route for the car and a second, different route for the truck) based on the respective vehicle type of the two vehicles (e.g., car versus truck) and/or based on the respective lane type associated with the two vehicles (e.g., carpool lane versus regular lane). Following block 1016, control of the example method 1000 of FIG. 10 proceeds to block 1018.

At block 1018, example user interface 314 of FIG. 3 presents the route (block 1018). For example, the processor 316 of FIG. 3 may provide one or more command(s) and/or instruction(s) to the user interface 314 instructing the user interface 314 to present the route generated by the processor 316. In some examples, such command(s) and/or instruction(s) may be predetermined and/or otherwise defined by an application and/or program executing on the onboard navigation system 134. In other examples, such command(s) and/or instruction(s) may be associated with one or more user input(s) received via the input device(s) 322 of the user interface 314 of FIG. 3. In response to such command(s) and/or instruction(s), the user interface 314 may present the route. Following block 1018, control of the example method 1000 of FIG. 10 proceeds to block 1020.

At block 1020, the example processor 316 of FIG. 3 determines whether lane and vehicle type-specific traffic information and/or the route is to continue being presented via the example user interface 314 of FIG. 3 (block 1020). For example, the processor 316 may receive one or more command(s) and or instruction(s) indicating that lane and vehicle type-specific traffic information and/or the route is not to continue being presented. In some examples, such command(s) and/or instruction(s) may be predetermined and/or otherwise defined by an application and/or program executing on the onboard navigation system 134. In other examples, such command(s) and/or instruction(s) may be associated with one or more user input(s) received via the input device(s) 322 of the user interface 314 of FIG. 3. If the processor 316 determines at block 1020 that lane and vehicle type-specific traffic information and/or the route is not to continue being presented, control of the example method 1000 of FIG. 10 returns to block 1002. If the processor 316 instead determines at block 1020 that lane and vehicle type-specific traffic information and/or the route is not to continue being presented, control of the example method 1000 of FIG. 10 ends.

FIG. 11 is an example processor platform 1100 capable of executing instructions to implement the methods of FIGS. 8 and 10 and the example onboard navigation system 134 of FIGS. 1-3. The processor platform 1100 of the illustrated example includes a processor 316. The processor 316 of the illustrated example is hardware. For example, the processor 316 can be implemented by one or more integrated circuit(s), logic circuit(s), microprocessor(s) or controller(s) from any desired family or manufacturer. The processor 316 of the illustrated example includes a local memory 1102 (e.g., a cache).

The processor 316 of the illustrated example is in communication with one or more example sensors 1104 via a bus 1106. The example sensors 1104 include the example GNSS/GPS receiver 302, the example compass 304, the example speed sensor 306 and the example lane type detector 308 of FIG. 3.

The processor 316 of the illustrated example is also in communication with a main memory including a volatile memory 1108 and a non-volatile memory 1110 via the bus 1106. The volatile memory 1108 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1110 may be implemented by flash memory and/or any other desired type of memory device. Access to the volatile memory 1108 and the non-volatile memory 1110 is controlled by a memory controller.

The processor 316 of the illustrated example is also in communication with one or more mass storage devices 1112 for storing software and/or data. Examples of such mass storage devices 1112 include floppy disk drives, hard drive disks, compact disk drives, Blu-ray disk drives, RAID systems, and digital versatile disk (DVD) drives. In the illustrated example, the mass storage device 1112 includes the example memory 318 of FIG. 3.

The processor platform 1100 of the illustrated example also includes a user interface circuit 1114. The user interface circuit 1114 may be implemented by any type of interface standard, such as an Ethernet interface, a universal serial bus (USB), and/or a PCI express interface. In the illustrated example, one or more input device(s) 322 are connected to the user interface circuit 1114. The input device(s) 322 permit(s) a user to enter data and commands into the processor 316. The input device(s) 322 can be implemented by, for example, an audio sensor, a camera (still or video), a keyboard, a button, a mouse, a touchscreen, a track-pad, a trackball, isopoint, a voice recognition system, a microphone, and/or a liquid crystal display. One or more output device(s) 324 are also connected to the user interface circuit 1114 of the illustrated example. The output device(s) 324 can be implemented, for example, by a light emitting diode, an organic light emitting diode, a liquid crystal display, a touchscreen and/or a speaker. The user interface circuit 1114 of the illustrated example may, thus, include a graphics driver such as a graphics driver chip and/or processor. In the illustrated example, the input device(s) 322, the output device(s) 324 and the user interface circuit 1114 collectively form the example user interface 314 of FIG. 3.

The processor platform 1100 of the illustrated example also includes a network interface circuit 1116. The network interface circuit 1116 may be implemented by any type of interface standard, such as an Ethernet interface, a universal serial bus (USB), and/or a PCI express interface. In the illustrated example, the network interface circuit 1116 includes the example radio transmitter 310 and the example radio receiver 312 of FIG. 3 to facilitate the exchange of data and/or signals with external machines (e.g., the remote server 136 of FIG. 4) via a network 1118 (e.g., a cellular network, a wireless local area network (WLAN), etc.), such as the example cellular network 138 of FIGS. 1 and 2.

Coded instructions 1120 for implementing the method of FIG. 8 and/or the method of FIG. 10 may be stored in the local memory 1102, in the volatile memory 1108, in the non-volatile memory 1110, in the mass storage device 1112, and/or on a removable tangible computer readable storage medium such as a CD or DVD.

FIG. 12 is an example processor platform 1200 capable of executing instructions to implement the method of FIG. 9 and the example remote server 136 of FIGS. 1, 2 and 4. The processor platform 1200 of the illustrated example includes a processor 416. The processor 416 of the illustrated example is hardware. For example, the processor 416 can be implemented by one or more integrated circuit(s), logic circuit(s), microprocessor(s) or controller(s) from any desired family or manufacturer. The processor 416 of the illustrated example includes a local memory 1202 (e.g., a cache).

The processor 416 of the illustrated example is in communication with a main memory including a volatile memory 1206 and a non-volatile memory 1208 via a bus 1204. The volatile memory 1206 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1208 may be implemented by flash memory and/or any other desired type of memory device. Access to the volatile memory 1206 and the non-volatile memory 1208 is controlled by a memory controller.

The processor 416 of the illustrated example is also in communication with one or more mass storage devices 1210 for storing software and/or data. Examples of such mass storage devices 1210 include floppy disk drives, hard drive disks, compact disk drives, Blu-ray disk drives, RAID systems, and digital versatile disk (DVD) drives. In the illustrated example, the mass storage device 1210 includes the example memory 418 of FIG. 4.

The processor platform 1200 of the illustrated example also includes a user interface circuit 1212. The user interface circuit 1212 may be implemented by any type of interface standard, such as an Ethernet interface, a universal serial bus (USB), and/or a PCI express interface. In the illustrated example, one or more input device(s) 422 are connected to the user interface circuit 1212. The input device(s) 422 permit(s) a user to enter data and commands into the processor 416. The input device(s) 422 can be implemented by, for example, an audio sensor, a camera (still or video), a keyboard, a button, a mouse, a touchscreen, a track-pad, a trackball, isopoint, a voice recognition system, a microphone, and/or a liquid crystal display. One or more output device(s) 424 are also connected to the user interface circuit 1212 of the illustrated example. The output device(s) 424 can be implemented, for example, by a light emitting diode, an organic light emitting diode, a liquid crystal display, a touchscreen and/or a speaker. The user interface circuit 1212 of the illustrated example may, thus, include a graphics driver such as a graphics driver chip and/or processor. In the illustrated example, the input device(s) 422, the output device(s) 424 and the user interface circuit 1212 collectively form the example user interface 414 of FIG. 4.

The processor platform 1200 of the illustrated example also includes a network interface circuit 1214. The network interface circuit 1214 may be implemented by any type of interface standard, such as an Ethernet interface, a universal serial bus (USB), and/or a PCI express interface. In the illustrated example, the network interface circuit 1214 includes the example radio transmitter 410 and the example radio receiver 412 of FIG. 4 to facilitate the exchange of data and/or signals with external machines (e.g., the onboard navigation system 134 of FIG. 3 and/or the mobile device 140 of FIG. 5) via a network 1216 (e.g., a cellular network, a wireless local area network (WLAN), etc.), such as the example cellular network 138 of FIGS. 1 and 2.

Coded instructions 1218 for implementing the method of FIG. 9 may be stored in the local memory 1202, in the volatile memory 1206, in the non-volatile memory 1208, in the mass storage device 1210, and/or on a removable tangible computer readable storage medium such as a CD or DVD.

FIG. 13 is an example processor platform 1300 capable of executing instructions to implement the method of FIG. 10 and the example mobile device 140 of FIGS. 1, 2 and 5. The processor platform 1300 of the illustrated example includes a processor 516. The processor 516 of the illustrated example is hardware. For example, the processor 516 can be implemented by one or more integrated circuit(s), logic circuit(s), microprocessor(s) or controller(s) from any desired family or manufacturer. The processor 516 of the illustrated example includes a local memory 1302 (e.g., a cache).

The processor 516 of the illustrated example is in communication with a main memory including a volatile memory 1306 and a non-volatile memory 1308 via a bus 1304. The volatile memory 1306 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1308 may be implemented by flash memory and/or any other desired type of memory device. Access to the volatile memory 1306 and the non-volatile memory 1308 is controlled by a memory controller.

The processor 516 of the illustrated example is also in communication with one or more mass storage devices 1310 for storing software and/or data. Examples of such mass storage devices 1310 include SD cards. In the illustrated example, the mass storage device 1310 includes the example memory 518 of FIG. 5.

The processor platform 1300 of the illustrated example also includes a user interface circuit 1312. The user interface circuit 1312 may be implemented by any type of interface standard, such as an Ethernet interface, a universal serial bus (USB), and/or a PCI express interface. In the illustrated example, one or more input device(s) 522 are connected to the user interface circuit 1312. The input device(s) 522 permit(s) a user to enter data and commands into the processor 516. The input device(s) 522 can be implemented by, for example, an audio sensor, a camera (still or video), a keyboard, a button, a mouse, a touchscreen, a track-pad, a trackball, isopoint, a voice recognition system, a microphone, and/or a liquid crystal display. One or more output device(s) 524 are also connected to the user interface circuit 1312 of the illustrated example. The output device(s) 524 can be implemented, for example, by a light emitting diode, an organic light emitting diode, a liquid crystal display, a touchscreen and/or a speaker. The user interface circuit 1312 of the illustrated example may, thus, include a graphics driver such as a graphics driver chip and/or processor. In the illustrated example, the input device(s) 522, the output device(s) 524 and the user interface circuit 1312 collectively form the example user interface 514 of FIG. 5.

The processor platform 1300 of the illustrated example also includes a network interface circuit 1314. The network interface circuit 1314 may be implemented by any type of interface standard, such as an Ethernet interface, a universal serial bus (USB), and/or a PCI express interface. In the illustrated example, the network interface circuit 1314 includes the example radio transmitter 510 and the example radio receiver 512 of FIG. 5 to facilitate the exchange of data and/or signals with external machines (e.g., the remote server 136 of FIG. 4) via a network 1316 (e.g., a cellular network, a wireless local area network (WLAN), etc.), such as the example cellular network 138 of FIGS. 1 and 2.

Coded instructions 1318 for implementing the method of FIG. 10 may be stored in the local memory 1302, in the volatile memory 1306, in the non-volatile memory 1308, in the mass storage device 1310, and/or on a removable tangible computer readable storage medium such as a CD or DVD.

From the foregoing, it will be appreciated that the disclosed methods and apparatus for generating and presenting lane and vehicle type-specific traffic information provide advantages over the approach for generating and presenting traffic information followed by conventional navigation systems. The lane and vehicle type-specific traffic information generated and presented via the disclosed methods and apparatus advantageously provides end users with traffic information of an increased level of detail and/or granularity relative to the traffic information generated and presented via conventional navigation systems. The increased granularity provided by the lane and vehicle type-specific traffic information of the disclosed methods and apparatus advantageously enables end users to more wisely plan and/or select their travel routes. For example, an end user driving a car and having a specific interest in traffic information for a carpool lane may utilize the lane and vehicle type-specific traffic information generated and presented via the disclosed methods and apparatus to differentiate and/or focus on traffic information pertaining to cars traveling in a carpool lane of a roadway, as opposed to cars and/or other types of vehicles traveling in other adjacent lanes of the roadway.

In some examples, an electronic device is disclosed. In some disclosed examples, the electronic device comprises a user interface to present lane and vehicle type-specific traffic information on a map. In some disclosed examples, the map includes a roadway having a plurality of adjacent lanes to carry vehicle traffic in a first direction. In some disclosed examples, the lane and vehicle type-specific traffic information is determined based on lane type identification data and vehicle type identification data provided by vehicles traveling on the lanes of the roadway in the first direction. In some disclosed examples, the electronic device is an onboard navigation system of a vehicle. In some disclosed examples, the electronic device is a mobile device.

In some disclosed examples of the electronic device, the lane and vehicle type-specific traffic information comprises a first graphic including at least one of a first symbol, a first color or a first line thickness indicative of a first lane type represented by a first portion of the lane and vehicle type-specific traffic information. In some disclosed examples, the lane and vehicle type-specific traffic information further comprises a second graphic including at least one of a second symbol, a second color or a second line thickness indicative of a second lane type represented by a second portion of the lane and vehicle type-specific traffic information, the second lane type different from the first lane type.

In some disclosed examples of the electronic device, the lane and vehicle type-specific traffic information comprises a first graphic including at least one of a first symbol, a first color or a first line thickness indicative of a first vehicle type represented by a first portion of the lane and vehicle type-specific traffic information. In some disclosed examples, the lane and vehicle type-specific traffic information further comprises a second graphic including at least one of a second symbol, a second color or a second line thickness indicative of a second vehicle type represented by a second portion of the lane and vehicle type-specific traffic information, the second vehicle type different from the first vehicle type.

In some disclosed examples of the electronic device, the lane type identification data provided by the vehicles traveling on the lanes of the roadway is determined based on the vehicles detecting lane type indicators located on the lanes of the roadway. In some disclosed examples, respective ones of the lane type indicators are associated with corresponding respective ones of the lanes of the roadway. In some disclosed examples, the lane type indicators comprise at least one of rumble strips detectable via a sound detector, RFID tags detectable via a RFID reader, or BLE tags detectable via a BLE reader.

In some disclosed examples of the electronic device, the user interface is further to present a route on the map. In some disclosed examples, the route is to be generated based on at least one of a vehicle type of a vehicle or a lane type for travel of the vehicle, and further based on the lane and vehicle type-specific traffic information.

In some examples, a method is disclosed. In some disclosed examples, the method comprises presenting lane and vehicle type-specific traffic information on a map of a user interface of an electronic device. In some disclosed examples, the map includes a roadway having a plurality of adjacent lanes to carry vehicle traffic in a first direction. In some disclosed examples, the lane and vehicle type-specific traffic information is determined based on lane type identification data and vehicle type identification data provided by vehicles traveling on the lanes of the roadway in the first direction. In some disclosed examples, the electronic device is an onboard navigation system of a vehicle. In some disclosed examples, the electronic device is a mobile device.

In some disclosed examples of the method, the lane and vehicle type-specific traffic information comprises a first graphic including at least one of a first symbol, a first color or a first line thickness indicative of a first lane type represented by a first portion of the lane and vehicle type-specific traffic information. In some disclosed examples, the lane and vehicle type-specific traffic information further comprises a second graphic including at least one of a second symbol, a second color or a second line thickness indicative of a second lane type represented by a second portion of the lane and vehicle type-specific traffic information, the second lane type different from the first lane type.

In some disclosed examples of the method, the lane and vehicle type-specific traffic information comprises a first graphic including at least one of a first symbol, a first color or a first line thickness indicative of a first vehicle type represented by a first portion of the lane and vehicle type-specific traffic information. In some disclosed examples, the lane and vehicle type-specific traffic information further comprises a second graphic including at least one of a second symbol, a second color or a second line thickness indicative of a second vehicle type represented by a second portion of the lane and vehicle type-specific traffic information, the second vehicle type different from the first vehicle type.

In some disclosed examples of the method, the lane type identification data provided by the vehicles traveling on the lanes of the roadway is determined based on the vehicles detecting lane type indicators located on the lanes of the roadway. In some disclosed examples, respective ones of the lane type indicators are associated with corresponding respective ones of the lanes of the roadway. In some disclosed examples, the lane type indicators comprise at least one of rumble strips detectable via a sound detector, RFID tags detectable via an on-vehicle RFID reader, or BLE tags detectable via an on-vehicle BLE reader.

In some disclosed examples of the method, the method further comprises presenting a route on the map of the user interface. In some disclosed examples, the route is generated based on at least one of a vehicle type of a vehicle or a lane type for travel of the vehicle, and further based on the lane and vehicle type-specific traffic information.

In some examples, a tangible machine readable storage medium comprising instructions is disclosed. In some disclosed examples, the instructions, when executed, cause a processor to present lane and vehicle type-specific traffic information on a map of a user interface of an electronic device. In some disclosed examples, the map includes a roadway having a plurality of adjacent lanes to carry vehicle traffic in a first direction. In some disclosed examples, the lane and vehicle type-specific traffic information is determined based on lane type identification data and vehicle type identification data provided by vehicles traveling on the lanes of the roadway in the first direction. In some disclosed examples, the electronic device is an onboard navigation system of a vehicle. In some disclosed examples, the electronic device is a mobile device.

In some disclosed examples of the tangible machine readable storage medium, the lane and vehicle type-specific traffic information comprises a first graphic including at least one of a first symbol, a first color or a first line thickness indicative of a first lane type represented by a first portion of the lane and vehicle type-specific traffic information. In some disclosed examples, the lane and vehicle type-specific traffic information further comprises a second graphic including at least one of a second symbol, a second color or a second line thickness indicative of a second lane type represented by a second portion of the lane and vehicle type-specific traffic information, the second lane type different from the first lane type.

In some disclosed examples of the tangible machine readable storage medium, the lane and vehicle type-specific traffic information comprises a first graphic including at least one of a first symbol, a first color or a first line thickness indicative of a first vehicle type represented by a first portion of the lane and vehicle type-specific traffic information. In some disclosed examples, the lane and vehicle type-specific traffic information further comprises a second graphic including at least one of a second symbol, a second color or a second line thickness indicative of a second vehicle type represented by a second portion of the lane and vehicle type-specific traffic information, the second vehicle type different from the first vehicle type.

In some disclosed examples of the tangible machine readable storage medium, the lane type identification data provided by the vehicles traveling on the lanes of the roadway is determined based on the vehicles detecting lane type indicators located on the lanes of the roadway. In some disclosed examples, respective ones of the lane type indicators are associated with corresponding respective ones of the lanes of the roadway. In some disclosed examples, the lane type indicators comprise at least one of rumble strips detectable via a sound detector, RFID tags detectable via a RFID reader, or BLE tags detectable via a BLE reader.

In some disclosed examples of the tangible machine readable storage medium, the instructions, when executed, are further to cause the processor to present a route on the map of the user interface. In some disclosed examples, the route is to be generated based on at least one of a vehicle type of a vehicle or a lane type for travel of the vehicle, and further based on the lane and vehicle type-specific traffic information.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method comprising:
presenting lane and vehicle type-specific traffic information on a map of a user interface of an electronic device, the map including a roadway having a plurality of adjacent lanes to carry vehicle traffic in a first direction, the lane and vehicle type-specific traffic information determined based on lane type identification data and vehicle type identification data provided by vehicles traveling on the lanes of the roadway in the first direction.

2. The method of claim 1, wherein the lane and vehicle type-specific traffic information comprises:
a first graphic including at least one of a first symbol, a first color or a first line thickness indicative of a first lane type represented by a first portion of the lane and vehicle type-specific traffic information; and
a second graphic including at least one of a second symbol, a second color or a second line thickness indicative of a second lane type represented by a second portion of the lane and vehicle type-specific traffic information, the second lane type different from the first lane type.

3. The method of claim 1, wherein the lane and vehicle type-specific traffic information comprises:
a first graphic including at least one of a first symbol, a first color or a first line thickness indicative of a first vehicle type represented by a first portion of the lane and vehicle type-specific traffic information; and
a second graphic including at least one of a second symbol, a second color or a second line thickness indicative of a second vehicle type represented by a second portion of the lane and vehicle type-specific traffic information, the second vehicle type different from the first vehicle type.

4. The method of claim 1, wherein the lane type identification data provided by the vehicles traveling on the lanes of the roadway is determined based on the vehicles detecting lane type indicators located on the lanes of the roadway.

5. The method of claim 4, wherein respective ones of the lane type indicators are associated with corresponding respective ones of the lanes of the roadway.

6. The method of claim 5, wherein the lane type indicators comprise at least one of rumble strips detectable via a sound detector, radio frequency identification (RFID) tags detectable via a RFID reader, or Bluetooth Low Energy (BLE) tags detectable via a BLE reader.

7. The method of claim 1, wherein the electronic device is an onboard navigation system of a vehicle.

8. The method of claim 1, wherein the electronic device is a mobile device.

9. The method of claim 1, further comprising presenting a route on the map of the user interface, the route generated based on at least one of a vehicle type of a vehicle or a lane type for travel of the vehicle, and further based on the lane and vehicle type-specific traffic information.

10. An electronic device, comprising:
a user interface to present lane and vehicle type-specific traffic information on a map, the map including a roadway having a plurality of adjacent lanes to carry vehicle traffic in a first direction, the lane and vehicle type-specific traffic information determined based on lane type identification data and vehicle type identification data provided by vehicles traveling on the lanes of the roadway in the first direction.

11. The electronic device of claim 10, wherein the lane and vehicle type-specific traffic information comprises:
a first graphic including at least one of a first symbol, a first color or a first line thickness indicative of a first lane type represented by a first portion of the lane and vehicle type-specific traffic information; and
a second graphic including at least one of a second symbol, a second color or a second line thickness indicative of a second lane type represented by a second portion of the lane and vehicle type-specific traffic information, the second lane type different from the first lane type.

12. The electronic device of claim 10, wherein the lane and vehicle type-specific traffic information comprises:
a first graphic including at least one of a first symbol, a first color or a first line thickness indicative of a first vehicle type represented by a first portion of the lane and vehicle type-specific traffic information; and
a second graphic including at least one of a second symbol, a second color or a second line thickness indicative of a second vehicle type represented by a second portion of the lane and vehicle type-specific traffic information, the second vehicle type different from the first vehicle type.

13. The electronic device of claim 10, wherein the lane type identification data provided by the vehicles traveling on the lanes of the roadway is determined based on the vehicles detecting lane type indicators located on the lanes of the roadway.

14. The electronic device of claim 13, wherein respective ones of the lane type indicators are associated with corresponding respective ones of the lanes of the roadway.

15. The electronic device of claim 14, wherein the lane type indicators comprise at least one of rumble strips detectable via a sound detector, radio frequency identification (RFID) tags detectable via a RFID reader, or Bluetooth Low Energy (BLE) tags detectable via a BLE reader.

16. The electronic device of claim 10, wherein the electronic device is an onboard navigation system of a vehicle.

17. The electronic device of claim 10, wherein the user interface is further to present a route on the map, the route to be generated based on at least one of a vehicle type of a vehicle or a lane type for travel of the vehicle, and further based on the lane and vehicle type-specific traffic information.

18. A tangible machine readable storage medium comprising instructions that, when executed, cause a processor to at least:
present lane and vehicle type-specific traffic information on a map of an electronic device, the map including a roadway having a plurality of adjacent lanes to carry vehicle traffic in a first direction, the lane and vehicle type-specific traffic information determined based on lane type identification data and vehicle type identification data provided by vehicles traveling on the lanes of the roadway in the first direction.

19. The tangible machine readable storage medium of claim 18, wherein the lane and vehicle type-specific traffic information comprises:
a first graphic including at least one of a first symbol, a first color or a first line thickness indicative of a first lane type represented by a first portion of the lane and vehicle type-specific traffic information; and
a second graphic including at least one of a second symbol, a second color or a second line thickness indicative of a second lane type represented by a second portion of the lane and vehicle type-specific traffic information, the second lane type different from the first lane type.

20. The tangible machine readable storage medium of claim 18, wherein the lane and vehicle type-specific traffic information comprises:
a first graphic including at least one of a first symbol, a first color or a first line thickness indicative of a first vehicle type represented by a first portion of the lane and vehicle type-specific traffic information; and
a second graphic including at least one of a second symbol, a second color or a second line thickness indicative of a second vehicle type represented by a second portion of the lane and vehicle type-specific traffic information, the second vehicle type different from the first vehicle type.

21. The tangible machine readable storage medium of claim 18, wherein the lane type identification data provided by the vehicles traveling on the lanes of the roadway is determined based on the vehicles detecting lane type indicators located on the lanes of the roadway.

22. The tangible machine readable storage medium of claim 21, wherein respective ones of the lane type indicators are associated with corresponding respective ones of the lanes of the roadway.

23. The tangible machine readable storage medium of claim 22, wherein the lane type indicators comprise at least one of rumble strips detectable via a sound detector, radio frequency identification (RFID) tags detectable via a RFID reader, or Bluetooth Low Energy (BLE) tags detectable via a BLE reader.

24. The tangible machine readable storage medium of claim 18, wherein the electronic device is an onboard navigation system of a vehicle.

25. The tangible machine readable storage medium of claim 18, wherein the instructions, when executed, are further to cause the processor to present a route on the map of the user interface, the route to be generated based on at least one of a vehicle type of a vehicle or a lane type for travel of the vehicle, and further based on the lane and vehicle type-specific traffic information.
